(19) United States
(12) Patent Application Publication
(10) Pub. No.: US 2017/0154339 A1
(43) Pub. Date: Jun. 1, 2017

(54) SYSTEMS AND METHODS FOR PROVIDING PEER TO PEER TECHNICAL SUPPORT FOR DEVICES OVER A NETWORK

(71) Applicant: 500BELOW, LLC, Nashville, TN (US)

(72) Inventor: Bill Kimberlin, Nashville, TN (US)

(21) Appl. No.: 15/258,766

(22) Filed: Sep. 7, 2016

Related U.S. Application Data
(60) Provisional application No. 62/215,106, filed on Sep. 7, 2015.

(51) Int. Cl. G06Q 30/00; G09B 5/02; B64D 47/08; B64F 5/40; G06Q 10/06; B64C 39/02

(52) U.S. Cl. CPC G06Q 30/016; G06Q 10/063112; B64C 39/024; B64D 47/08; B64F 5/40; G09B 5/02; B64C 2201/146

(57) ABSTRACT

A method is described that includes receiving identification of a drone configuration from at least one user. The method includes receiving identification of training abilities from a plurality of trainers, wherein a training ability comprises an ability to provide assistance in resolving technical issues involving one or more drone configurations. The method includes receiving a training request from the at least one user for assistance in performing at least one action involving the drone configuration. The method includes identifying a trainer of the plurality of trainers with training ability applicable in assisting the at least one user in performing the at least one action. The method includes providing a training session between the at least one user and the trainer, wherein the training session comprises an electronic display simultaneously visible on a mobile device of the at least one user and a mobile device of the trainer.

### CROSS REFERENCE TO RELATED APPLICATIONS

This application claims the benefit of U.S. application Ser. No. 62/215,106, filed Sep. 7, 2015.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### FIELD OF THE INVENTION

The present inventive concept relates to providing peer to peer technical support for drone devices/displays over a network.

So that the manner in which the present application can be better understood, certain illustrations and figures are appended hereto. It is to be noted, however, that the drawings illustrate only selected embodiments and elements of the systems and methods for providing peer to peer technical support for devices over a network and are therefore not to be considered limiting in scope. Further, the systems and methods for providing peer to peer technical support for devices over a network as described herein may admit to other equally effective embodiments and applications.

### BRIEF DESCRIPTION OF THE FIGURES

FIG. 1 is a screen shot showing login/registration page, under an embodiment.

FIG. 2 is a screen shot providing an option to create an account, under an embodiment.

FIG. 3 is a screen shot providing an option to create a profile, under an embodiment.

FIG. 4 is a screen shot providing an option to create a profile, under an embodiment.

FIG. 5 is a screen shot providing an option to create a profile including selection of a device, under an embodiment.

FIG. 6 is a screen shot providing an option to create a profile including selection of a display, under one embodiment.

FIG. 7 is a screen shot showing account type options, under an embodiment.

FIG. 8 is a screen shot showing payment options, under an embodiment.

FIG. 9 is a screen shot asking user to verify mobile device, under an embodiment.

FIG. 10 is a screen shot showing sign in page, under an embodiment.

FIG. 11 is a screen showing a device picture, under an embodiment.

FIG. 12 is a screen shot showing support selections, under an embodiment.

FIG. 13 is a screen shot showing support selections, under an embodiment.

FIG. 14 is a screen shot of application asking user to confirm the technical support issue, under an embodiment.

FIG. 15 is a screen shot showing payment information, under an embodiment.

FIG. 16 is a progress screen alerting user that application is matching operator to user, under an embodiment.

FIG. 17 is a screen shot showing information regarding the operator, under an embodiment.

FIG. 18 is a progress screen alerting user that application is connecting the user with device operator, under an embodiment.

FIG. 19 is a screen shot showing a support session between operator and user, under an embodiment.

FIG. 20 is a screen allowing user to rate the operator, under an embodiment.

FIG. 21 is a screen shot providing a receipt, under an embodiment.

FIG. 22 is a welcome screen shot, under an embodiment.

FIG. 23 is a screen shot showing a sign in page, under an embodiment.

FIG. 24 is a screen showing a selected device/display combination, under an embodiment.

FIG. 25 is a screen shot showing support selections, under an embodiment.

FIG. 26 is a screen shot showing support selections, under an embodiment.

FIG. 27 is a screen shot asking the user to confirm user's selection of support topic, under an embodiment.

FIG. 28 is a screen shot showing payment information and providing estimated success rate and estimated time duration of support session regarding selected support topic, under an embodiment.

FIG. 29 is a progress screen alerting user that application is searching aviators who may assist user, under an embodiment.

FIG. 30 is a screen shot showing information regarding the aviator, under an embodiment.

FIG. 31 is a screen shot showing a support session between aviator and user, under an embodiment.

FIG. 32 is a screen shot showing receipt and opportunity of user to rate the experience and provide additional comments, under an embodiment.

FIG. 33 is a thank you screen, under an embodiment.

FIG. 34 shows a profile setup screen, under an embodiment.

FIG. 35 shows a profile setup screen, under an embodiment.

FIG. 36 shows a profile setup screen, under an embodiment.

FIG. 37 shows a profile setup screen, under an embodiment.

FIG. 38 shows an interface for providing device information, under the embodiment.

FIG. 39 shows an interface for providing device information, under the embodiment.

FIG. 40 shows an interface for providing device information, under the embodiment.

FIG. 41 shows an interface for providing device information, under the embodiment.

FIG. 42 is a screen for setting up the payment profile for giving training or requesting training, under an embodiment.

FIG. 43 shows the payout profile for paying user, under one embodiment.

FIG. 44 shows a welcome screen, under one embodiment.

FIG. 45 shows a screen for setting up a payment profile, under one embodiment.

FIG. 46 is a screen that allows the user to identify the areas expertise to train other users, under an embodiment.

FIG. 47 is a screen providing opportunity to offer training, under an embodiment.

FIG. 48 shows a receipt screen, under an embodiment.

FIG. 49 shows a message request training services, under an embodiment.

FIG. 50 shows a training request invitation, under one embodiment.

FIG. 51 shows a training request invitation, under one embodiment.

FIG. 52 shows a chat session between drone trainer and trainee, under one embodiment.

FIG. 53 shows a screen allowing assessment of training, under one embodiment.

FIG. 54 is a screen allowing input of training feedback, under an embodiment.

FIG. 55 provides a thank you page, under one embodiment.

FIG. 56 is a screen allowing user to request more drone training, under one embodiment.

FIG. 57 provides a central application dashboard for providing and receiving training, under one embodiment.

FIG. 58 is a screen that allows the user to select training categories, under one embodiment.

FIG. 59 is a screen that allows the user to select training categories, under one embodiment.

FIG. 60 is a screen that allows the user to select training categories, under one embodiment.

FIG. 61 represents a payment options page, under one embodiment.

FIG. 62 provides a training request page, under one embodiment.

FIG. 63 provides a training request page, under one embodiment.

FIG. 64 shows a training session, under one embodiment.

FIG. 65 provides a training feedback page, under one embodiment.

FIG. 66 provides a training feedback page, under one embodiment.

FIG. 67 provides a training feedback page, under one embodiment.

FIG. 68 provides a training feedback page, under one embodiment.

FIG. 69 shows a screen providing options when a trainer is not available to assist, under one embodiment.

FIG. 70 shows a thank you screen, under an embodiment.

FIG. 71 show a screen providing options when a trainer is not available to assist, under one embodiment.

FIG. 72 shows a screen allowing user to offer training, under one embodiment.

FIG. 73 shows a thank you screen including notification of receipt, under an embodiment.

FIG. 74 is the screen that allows user to either give training or get training, under one embodiment.

FIG. 75 show an interface for updating a user/trainer skillset, under one embodiment.

FIG. 76 shows a dashboard screen allowing user initial opportunity to specify device information, under one embodiment.

FIG. 77 is a screen that allows the user to select training categories, under one embodiment.

FIG. 78 shows a message request training services, under an embodiment

FIG. 79 shows a 500Below splash page, under one embodiment.

FIG. 80 shows a global menu screen allowing user access to all functions within the application, under one embodiment.

FIG. 81 is a training pilot screen allowing allows user to access and update training skills, under one embodiment.

FIG. 82 show a virtual hangar providing user information as it pertains to user's drone aircraft, under one embodiment.

FIG. 83 is a training history screen, under one embodiment.

FIG. 84 shows a method for providing peer to peer technical support for devices over a network, under an embodiment.

### DETAILED DESCRIPTION

An unmanned aerial vehicle (UAV), commonly known as a drone, and also referred to as a remotely piloted aircraft (RPA) by the International Civil Aviation Organization (ICAO), is an aircraft without a human pilot aboard. Its flight is controlled either autonomously by onboard computers or by the remote control of a pilot on the ground or in another vehicle.

To distinguish UAVs from missiles, a UAV is defined as a powered, aerial vehicle that does not carry a human operator, uses aerodynamic forces to provide vehicle lift, can fly autonomously or be piloted remotely, can be expendable or recoverable, and can carry a lethal or nonlethal payload. Therefore, cruise missiles are not considered UAVs because, like many other guided missiles, the vehicle itself is a weapon that is not reused, though it is also unmanned and in some cases remotely guided. Many different names are used for these aircraft. They are unpiloted aerial vehicle (UAV), remote piloted aircraft system (RPAS), and model aircraft. They are referred to herein as drones, drone devices, or UAVs.

Drones have widespread application in the civilian/private market. Private citizens and media organizations use drones for surveillance, recreation, news-gathering, or personal land assessment. Drones also have been shown to have many other civilian uses, such as in agriculture, movies, and the construction industry. Drones have also been used in search and rescue operations. Applications of drones in the private sector are nearly endless.

Systems and methods are described herein for providing technical support for drone device owners over a network. A user of a particular device (and corresponding dependent display as further described below) may have one or more technical problems with the device. Normally, technical support may be provided to the user through phone or in store technical support services. Further, online support may often be available. However, technical support is often difficult or even impossible to obtain for owners of drone devices.

For example, an individual may own the DJI Phantom 3® series and may use an iPad Air application to function as a display (i.e. for displaying device data including real time video) and to provide navigational control of the drone. The iPad Air and application running thereon may simply be referred to as a dependent display or dependent display device. The dependent display device may provide a real time display of video captured by the drone. The display device may also provide a wealth of additional device data including altitude, speed and GPS coordinates. If the user experiences a problem with the drone and/or dependent display, the user may call traditional customer/technical support. However, users may pair any number of dependent displays with a particular drone resulting in an escalating number of potential drone/display combinations. The increasing number of drone/display combinations emerging in the market outpaces the capabilities of traditional technical support call center providers needed to manage pre and post flight support issues.

As indicated above, systems and methods are described herein for providing technical support to drone users/operators through a peer-to-peer network. The company known as 500 Below (the “Company”) provides an application operating on a mobile device that facilitates online connections between users of like devices, e.g. users of similar drone technology. The application may run natively on iOS, Android, and Windows mobile computing applications. Further the application may also comprise an HTML client application running on a desktop or laptop computer. The application, its functionality and workflow is described in detail below. In the discussion below, it is assumed that the application runs within an iOS computing environment.

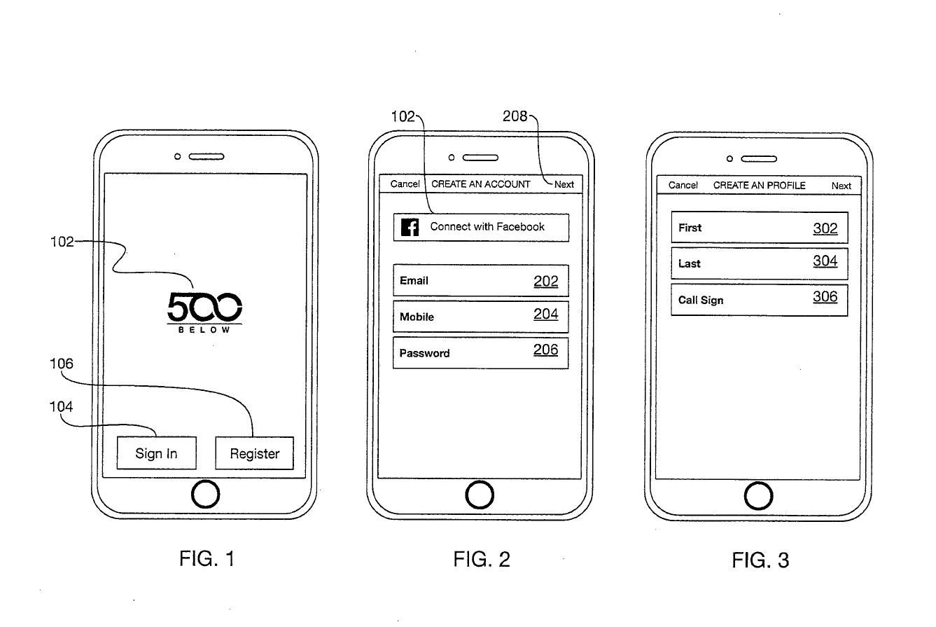

FIG. 1 shows the opening screen of the 500 Below application (hereinafter referred to as the “application”, the “platform”, the “500 Below application”, or the “500 Below platform”). FIG. 1 features the company logo 102, a sign in button 104 and a register button 106. When a user selects the registration button 106, the application walks the user through an initial registration process. The screen of FIG. 2 provides users with a choice of registering with the application using Facebook credentials 210. Alternatively, a user may register with the application using by entering an email address 202, mobile phone number 204 and a password 206. A user then selects the next 208 button to proceed to the next page.

FIG. 3 continues the registration process by asking the user to create a user profile. As seen in FIG. 3, the user enters first name 302, last name 304, and a call sign 306. For example, FIG. 3 shows a profile for Jim Williams who wishes to be known as RotorJim.

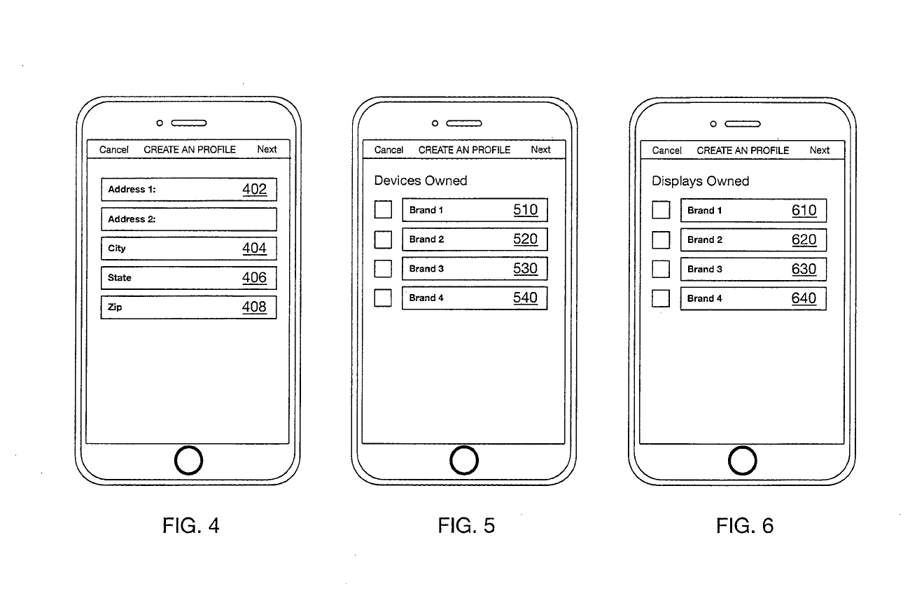

FIGS. 4-6 show screens that continue the user profile creation. The page shown in FIG. 4 requests address 402, city 404, state 406 and zip code 408 from the user. FIGS. 5 and 6 request a user to indicate one or more devices 510-540 (i.e. drones) owned and one or more corresponding dependent displays 610-640, i.e. devices running an application for display of drone data and providing control of drone operations. FIG. 5 may provide a drop down menu, e.g. 510, for selecting a manufacturer/provider of a device. After selecting a particular manufacturer/provider (e.g. DJI), the application may provide another follow up drop down menu for selecting a list of drones offered by the particular manufacturer/provider (e.g. Inspire 1®, Phantom 1®, Phantom 2®, Phantom 2 Vision®, Phantom FC40®, Phantom 3®, etc.). Using drop down menu functionality, the user may indicate ownership of a DJI Phantom 3® series drone. The user may then use a drop down menu (e.g. FIG. 6, 610) to identify a corresponding dependent display device that may be used in connection with the selected/identified drone device. The user may under one embodiment identity as the dependent display an iPad Air running a particular application for display of drone data and for providing control of drone operations. Note that the user may revisit these two screens (i.e. have an opportunity to update or select additional or different device/display combinations) when subsequently logging into the application as further described below.

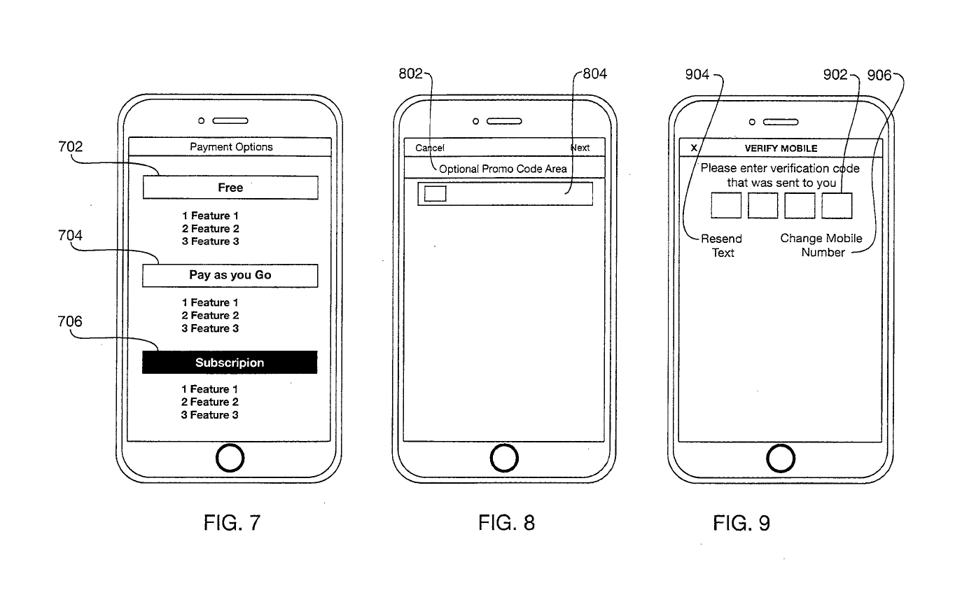

FIGS. 7-9 continue with the overall registration process. FIG. 7 offers three application plans. First, a user may select a “Free” option 702. This plan may provide limited functionality. Second, a user may select a “Pay as You Go” 704 option. This options allows a user access to the application on a case by case basis. For example, a user may need assistance with a firmware update regarding a particular drone device. The user may log into and use the application to match with an experienced technician who may then assist the user with the update. The user may then simply pay for the single use of the application. Third, a user may purchase a subscription 706. The user may then be granted unlimited access to the service. Under one embodiment, subscription rates are priced such that 500 Below may then pay technical support providers for their services.

The screen shown in FIG. 8 solicits payment information. The user may provide credit card information 804 so that user's card is automatically charged upon completion of a support session brokered by the 500 Below platform. The same screen allows the user to enter an optional promotional code 802.

Upon completion of the registration process, the application may send the user a four digit code to the user's mobile phone (provided during the registration process). The user then enters a verification code using the four text boxes 902 of the verification screen as shown in FIG. 9. Alternatively, the user may request that the application resend 904 a text with a verification code. In addition, the user is presented with an option 906 to change the user's mobile phone number.

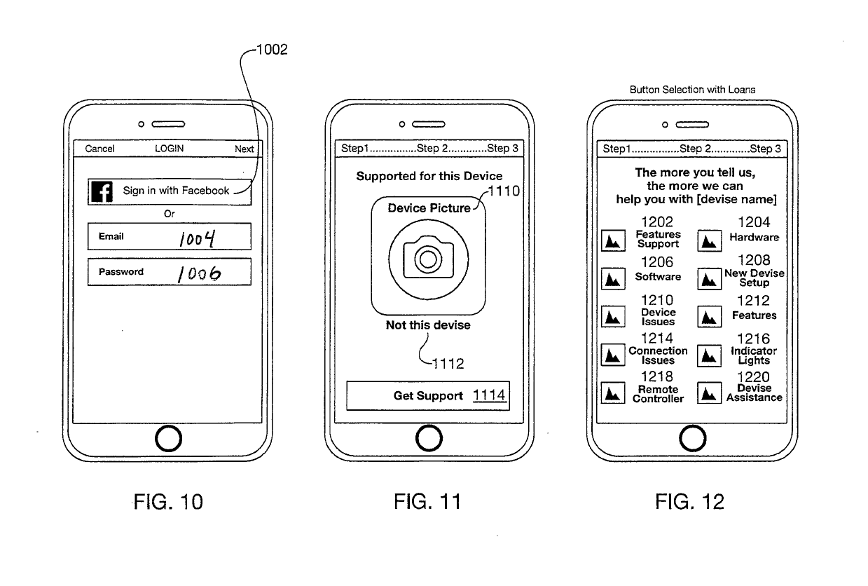

FIGS. 10-21 provide a use case story of a user engaging the application to resolve a technical issue, under one embodiment. With respect to FIG. 10, a user may log into the application using Facebook credentials 1002. Alternatively, a user may login to the application using email address 1004 and password 1006. The screen of FIG. 11 presents the user with a picture 1110 of the device that the user indicated or identified during registration. Under an alternative embodiment, the user may not have selected any device during registration. In this event, the screen of FIG. 11 presents a stock photo. If the screen shows the device with which the user needs help, the user may simply select the Get Support button 1114.

However, the user may need assistance with a different device. Or as indicated above, the user may not have selected any device at all during the registration process. In either case, the user may select the Not This Device 1112 link. Selection of this link clicks the user back to the selection screens provided in FIGS. 5 and 6. The user may then select a different device and dependent display using the methods as already described in detail above.

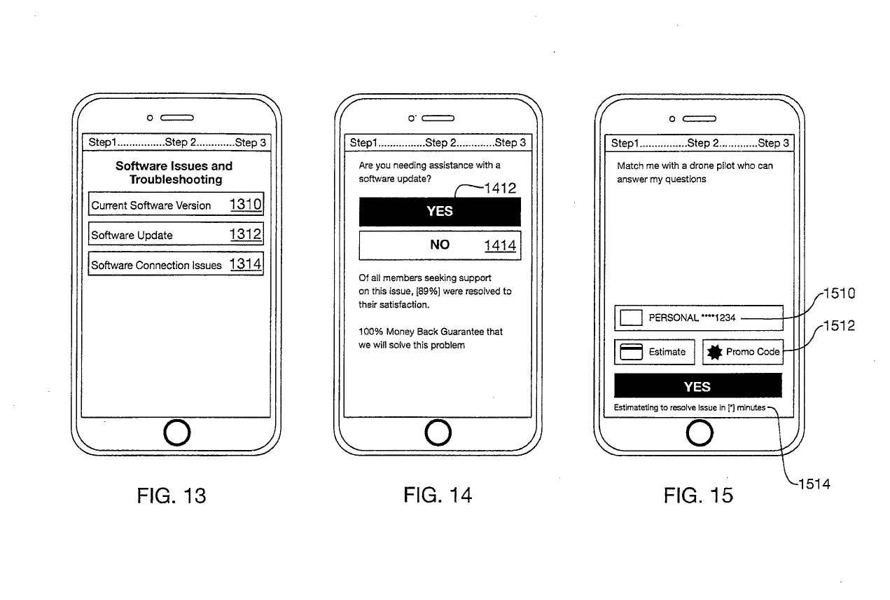

Once the user has identified a device/display combination, the user selects the Get Support button 1114. The user is then directed to the page as seen in FIG. 12 which presents the user with various support categories: Features Support 1202, Hardware 1204, Software 1206, New Device Setup 1208, Device Issues 1210, Features 1212, Connection Issues 1214, Indicator Lights 1216, Remote Controller 1218, and Device Assistance 1220. Of course, these categories are exemplary and embodiments of the application are not limited to such categories and may offer additional or different sets of technical support categories. Once the user has selected a support category, the user is then presented with a list of corresponding potential technical support issues. With continued reference to the example, the user has selected software (FIG. 12, 1206). The screen of FIG. 13 then presents the following technical support categories: Current Software Version 1310, Software Update 1312, and Software Connection Issues 1314. Under this example, the user selects Software Update 1312. The user is then asked via the screen of FIG. 14 to confirm 1410 the selection: “Are you needing assistance with a software update?”. In considering whether to select yes 1412 or no 1414, the user may be informed that “Of all members seeing support on this issue, 89% were resolved to their satisfaction.” The screen may also promise a “100% Money Back Guarantee” if the application is unable to solve the problem

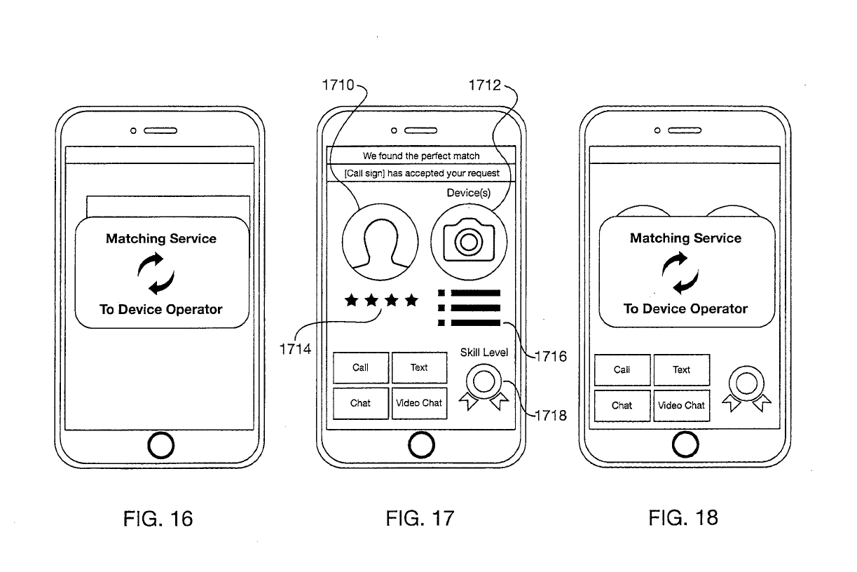

If the user selects yes 1412 in FIG. 14, the user is presented with payment information 1510 along with an ability to enter any promotional codes 1512. The user is also presented with an estimate 1514 of how long it may take to resolve the issue. If the user proceeds by selecting yes 1506, the user then sees FIG. 16 which is simply a progress screen informing the user that the application is matching the requested service with technical support device operator.

The screen of FIG. 17 shows the user a match with a particular device operator. The screen shows a picture 1710 of the device operator, information 1716 regarding the operator, a picture 1712 of the device, the star rating 1714 of the device operator, and the skill level 1718 of the device operator. The user may then elect to call the device operator, text the device operator, video chat with the device operator or chat with the device operator within the application. FIG. 18 is simply a progress screen indicating that the user is being connected to device operator.

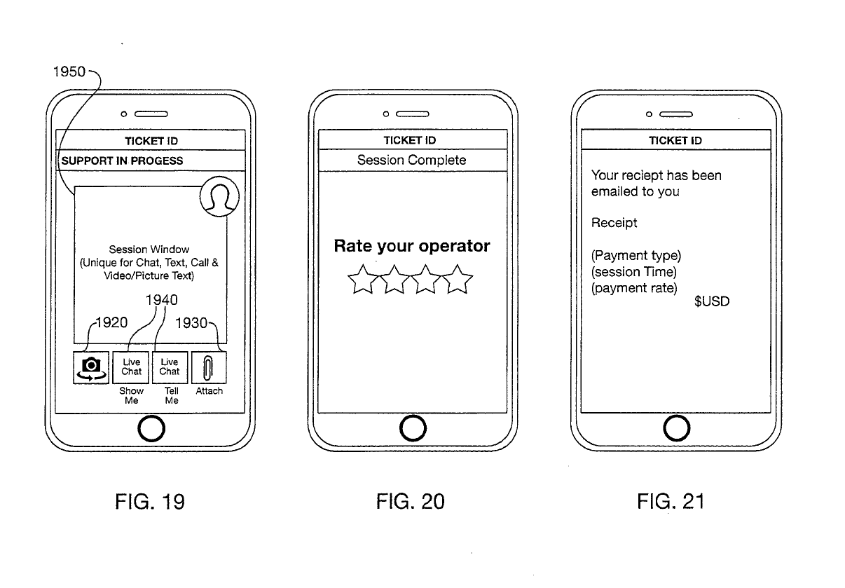

The screen of FIG. 19 shows the session in progress. The screen shows the session Window 1950. The session window may show live video of the operator under one embodiment. Alternatively, the user and support provider may simply communicate via phone. The user may chat options 1940 to send written text to the operator. The user may select the video button 1920 to face the mobile phone's camera forward and show the operator live video of the problem, e.g. the user may show the operator live video of certain buttons on a device that blink in a particular order at a particular point in a technical operation. The user may select the attach 1930 button to upload and send documents to the operator. In FIG. 20, the user is asked to rate the operator. Under one embodiment, the device operator rates the user. Under another embodiment, the user rates the device operator. Under another embodiment, either parties may rate the other. The screen of FIG. 21 provides the user with a receipt.

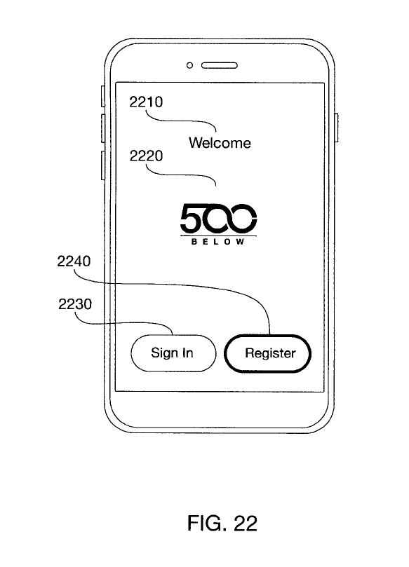

FIGS. 22-33 provide another use case story of a user engaging the application to resolve a technical issue, under one embodiment.

The screen of FIG. 22 shows a welcome screen 2210. The screen features company logo 2220 and sign in 2230 or register options 2240.

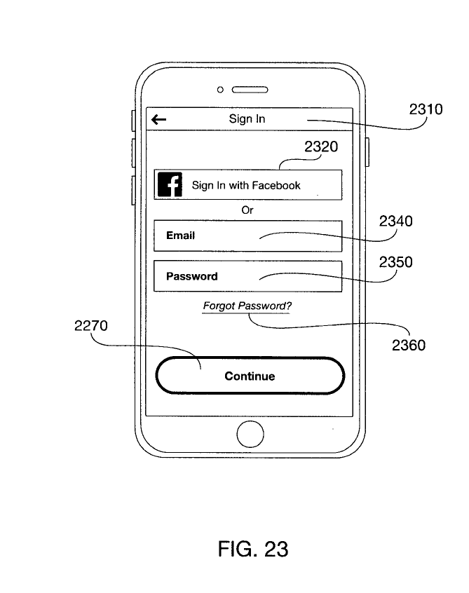

FIG. 23 shows a sign in screen 2310. A user may sign into the application using either Facebook credentials or email 2340/password credentials 2350. The screen provides a forgot password 2360 link and continue button 2370.

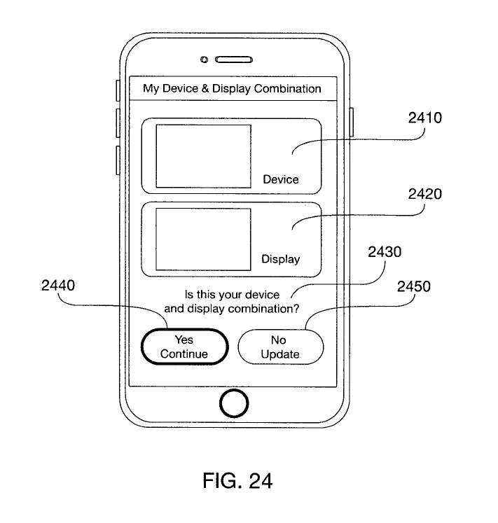

FIG. 24 shows the user a picture of the device 2410 and the display 2420 that the user identified during the registration process as already described above with respect to FIGS. 5 and 6. The screen asks 2430 “Is this the device and display combination?” Under an embodiment, the user may not have selected any device/display during registration. In this event, the screen of FIG. 24 presents stock photos for device and display. If the screen shows the device/display combination with which the user needs help, the user may simply elect to continue 2440 the process. However, the user may need assistance with a different device/display combination. Or as indicated above, the user may not have selected any device/display at all during the registration process. In either case, the user may select the No/Update button 2450 upon which the user may return to the selection screens provided in FIGS. 5 and 6. The user may then select/update a device and dependent display using methods as already described in detail above.

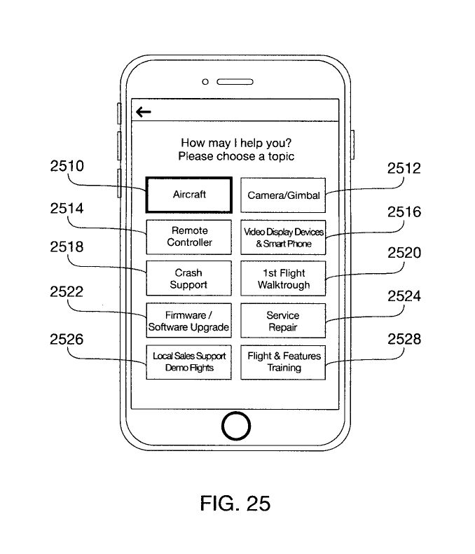

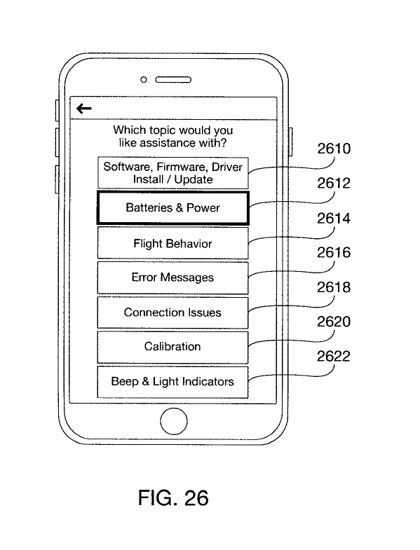

Once the user has selected a device/display combination, the user is then directed to the page as seen in FIG. 25 which presents the user with various support categories including Aircraft 2510, Camera/Gimbal 2512, Remote Controller 2514, Video Display & Smart Phone 2516, Crash Support 2518, 1st Flight Walkthrough 2520, Firmware/Software Upgrade 2522, Service Repair 2524, Local Sales Support Demo Flights 2526, and Flight & Features Training 2528. Continuing with this example, the user selects Aircraft. The user then proceeds to the screen of FIG. 26. This screen asks the user to identify a particular topic with which the user needs assistance. The listed topics correspond to the Aircraft selection of the previous screen. Such topics include Software, Firmware, Driver Install/Update 2610, Batteries and Power 2612, Flight Behavior 2614, Error Messages 2616, Connection Issues 2618, Calibration 2620, and Beep & Light Indicators 2620. Continuing with the example, the user selects battery and power.

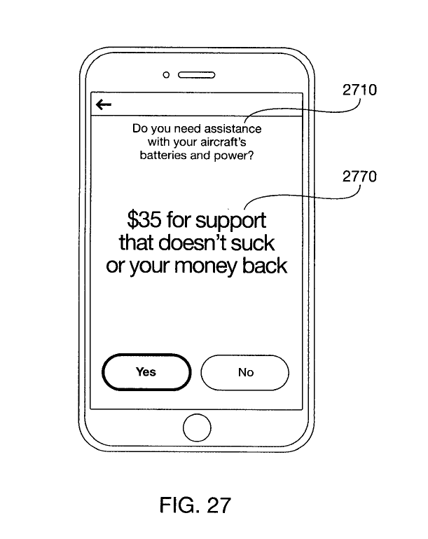

FIG. 27 asks the user to confirm the technical support selection. For example, the screen states “Do you need assistance with your aircraft's batteries and power?” 2710. The screen also provides an estimate of the cost and an assurance of quality service or money back. The screen states “$35 for support that doesn't suck or your money back” 2720. Continuing with the example, the user elects to proceed and presses the yes button.

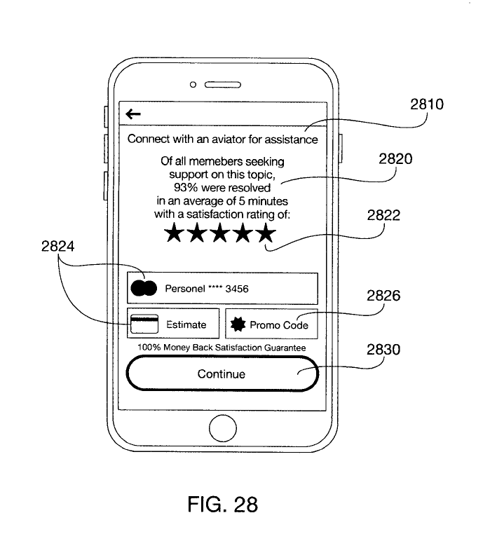

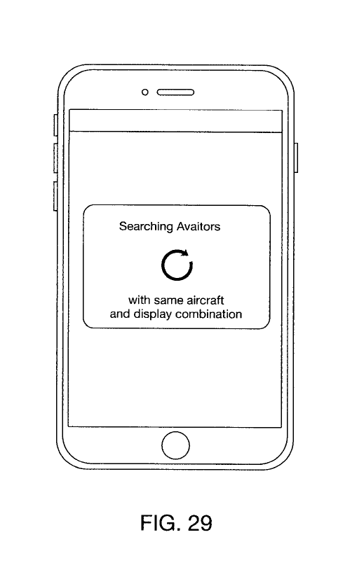

FIG. 28 alerts the user that the application is connecting with an aviator who may provide assistance 2810. The screen may also state that “Of all members seeking support on this topic, 93% were resolved in an average of 5 minutes with a satisfaction rating of:” 2820. The rating may be represented as a five star rating graphic 2822 under an embodiment. FIG. 28 also provides payment information 2824 along with an option to enter a promotional code 2826. The screen also provides of a 100% Money Back Satisfaction Guarantee 2828. If the user elects to continue 2830, the user proceeds to FIG. 29 which simply alerts the user that the application is searching for aviators who own the same device/display configuration or who are otherwise able to assist the user with the particular technical issue.

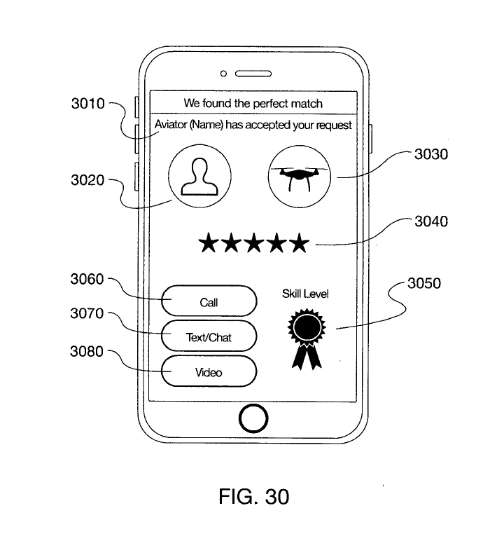

The screen of FIG. 30 shows the user a match with a particular aviator and indicates that the “Aviator (Name) has accepted your request” 3010. The screen shows a picture 3020 of the aviator, a picture of the device 3030, the star rating 3040 of the device operator, and the skill level 3050 of the device operator. The user may then elect to call 3060 the aviator, text/chat 3070 with the aviator, or video chat 3080 with the aviator.

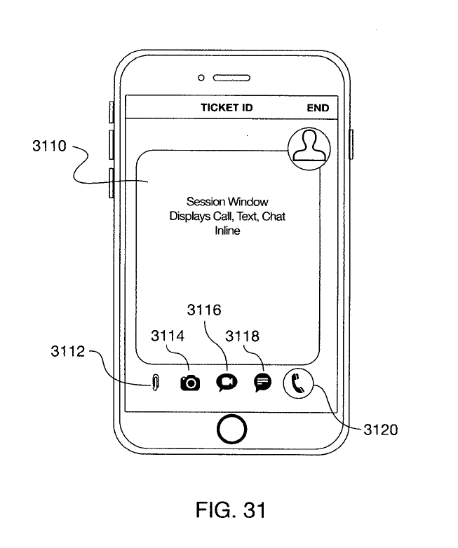

The screen of FIG. 31 shows the session in progress. The screen shows the session Window 3110. The session window may show live video of the aviator under one embodiment. Alternatively, the user and aviator may simply communicate via phone call or text messaging. During the technical support session, the user may select the attach 3112 button to upload and send documents to the aviator. The user may select the camera 3114 button to use the phone's camera to take a picture (e.g. picture of device that assists in identifying the source of a technical issue) and then send the picture to the aviator. The user may also select the video button 3116 to face the mobile phone's camera forward and show the operator live video of the problem, e.g. the user may show the operator live video of certain buttons on a device that blink in a particular order at a particular point in a technical operation. The user may select the text 3118 to send the aviator text messages. The user may select the phone 3120 button to toggle between phone call and video chart modes.

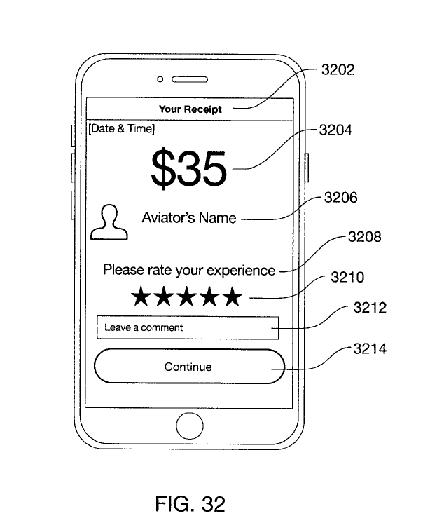

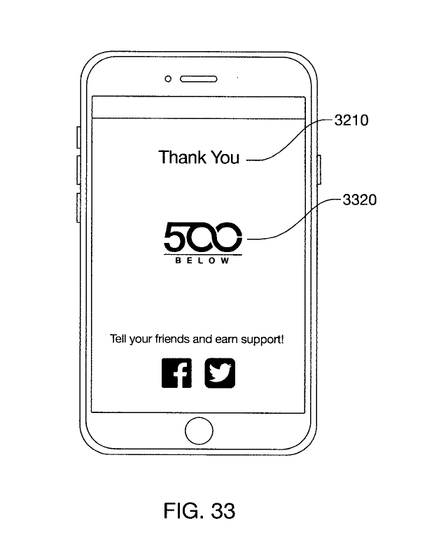

After completion of the session, the screen of FIG. 32 provides the user with a receipt 3202 stating cost 3204 (e.g., $35). The screen also provides the aviator's name 3206 and asks the user to rate his or her experience with the aviator 3208. using five star rating 3210. The user may also enter free form comments using the provided text box 3212. Once the user submits 3214 the rating and any additional information or comments, the user proceeds to the screen of FIG. 33 which comprises a final Thank You screen 3310 featuring company logo 3320.

The 500 Below application contemplates two types of users under an embodiment. First there is a user who seeks technical assistance to fix or diagnose a technical problem. Second, there are users who have experience with respect to particular device/display combinations. Therefore, experiences users may offer their services through the 500 Below application. Under one embodiment, support operators/aviators are simply enrolled and then matched through the application to users seeking assistance according to specifically identified device/display issues. Under an alternative embodiment, a user may encounter a screen during registration that allows self-identification as a support operator/aviator. The application may then prompt such user to provide information regarding his or her experience level with respect to particular device/display combinations (and with respect to issues corresponding to such device/display combinations). The application may request this information through a workflow of selections or may solicit free flow input from the user. Further, the application may request that a self-identified operator/aviator provide an hourly rate or some other indication of cost for his or her services.

It should also be noted that users using the application to resolve a technical issue may themselves be asked to become a technical support provider. As just one example, the application (upon completion of a technical support session) may prompt the user with an opportunity to become an operator/aviator. The application may then prompt such user to provide information regarding his or her experience level with respect to particular device/display combinations (and with respect to issues corresponding to such device/display combinations). The application may request this information through a workflow of selections or may solicit free flow input from the user. Further, the application may request that a user provide an hourly rate or some other indication of cost for his or her services.

Note that the application may itself function as a training tool. For example, an operator or aviator may wish to expand the range of services that he or she provides. The operator/aviator may then use the application to match with other operators/aviators to learn technical support operations for certain device/display combinations. The application may under one embodiment simply apply the cost of such training against the amount owed the operator/aviator for technical support sessions previously provided to users.

Further note that the application may integrate with sales activities. As seen in FIG. 25, a user may select “Local Sales Support Demo Flights”. The application may then conduct a geofenced search of other users who have a particular device/combination of interest to the user. The application may then broker a connection in order to facilitate a meeting between user and device/display owner for purposes of a demo flight. This demo flight service may be integrated into third party sites such that visitors to third party sites may simply click through to use the application services for scheduling demo flights.

Under one embodiment, a user initiates an application session with an aviator to diagnose a software update issue. The user and the aviator communicate through the session window in an attempt to resolve the software update problem. The aviator may monitor the progress of the call in real time using a DEFCON 5 scale or analogous metric. In other words, level 5 represents that all is well with the call and that the session is proceeding toward a satisfactory resolution. At the other end of the scale, level 1 represents that the session is in trouble and that the Aviator clearly envisions failure in resolving the user's issue. The aviator may self-rate the call and move the metric up or down levels in real time using an application dashboard.

Continuing with the example, the aviator may feel that the current session is proceeding well and may rate the call at level 4. However, the software update may prove more difficult than expected to resolve. Accordingly, the aviator may downgrade the session to level 3. Once the aviator rates the session at a level 2 or below, the application sends out a distress signal to other fellow aviators registered with the system. The distress signal or alert is sent to those aviators who own the same device/display combination as the user, i.e. the device/display combination that is the subject of the current real time support session. Further, aviators may monitor incoming alerts using the application. When a fellow aviator sees an incoming alert, the aviator then may offer his or her assistance. In other words, the aviator uses the application to transmit an “assist” signal to the aviator currently handling the technical support session. The current “in session” aviator monitors incoming assist signals using the same dashboard available to such aviator for rating the level of success or failure of the session, i.e. using level 1 to level 5. The current aviator may then accepts an “assist” from a fellow aviator who will then join the session in real time. The current and fellow aviator may then work together to diagnose or resolve the problem. When the current aviator invites the fellow aviator to join the session, the current aviator agrees to a 50/50 split of payment.

Another embodiment of the DEFCON 5 level system is described below.

DEFCON 1 (color code white)

Exercise Term: Support Incident Failure.

Description: Maximum readiness. A group of aviators may now barge in creating a group support chat or call. Support issue able to be smoking hole in the ground.

Readiness: Maximum readiness. A group of aviators may now barge in creating a group support chat or call. Support issue able to be smoking hole in the ground.

Result Pay: Loss of Fee. No support money to share unless saved in DEFCON 1. In which case, money is split evenly among all support aviators.

DEFCON 2 (color code red)

Exercise Term: Barge In.

Description: Next step to war on quality control. “Barge In” is now enabled.

Readiness: Air Support Forces ready to deploy and may barge in on call at will to assist or copilot the issue to resolution.

Result Pay: If resolved in DEFCON 2, Pay is split 50/50 between first responder and copilot providing assistance.

DEFCON 3 (color code yellow)

Exercise Term: Severe Turbulence, Ease Drop Now Enabled.

Description: Increase in support force readiness above that required for normal readiness. A Squawk alert is now sent to support squadron. Squawk Alerts will be coded for each type support group.

Readiness: Air Support ready to mobilize in 1 minute. System now allows for “ease dropping” on call to gather intelligence. Other support aviators may now ease drop the call and gather intelligence on status of first responder and caller. Support aviator can see supporting aviators in line to assist, however caller remains unaware of back up support. Back up aviators may now communicate with each other via call or chat to discuss who is best suited to barge the call and assist/copilot the support/incident call.

Result Pay: If resolved in DEFCON 3, 100% to first responder.

DEFCON 4 (color code green)

Exercise Term: Light Turbulence, Support Description visible to aviator support community.

Description: Increased intelligence watch and strengthened support measures.

Readiness: Above normal readiness, Support Aviator experiencing low risk level trouble shooting.

Result Pay: 100% to First Responder.

DEFCON 5 (color code blue)

Exercise Term: First responder aviator on active call. All is Good.

Description: Lowest state of support readiness.

Readiness: Normal readiness, call going well. Support topic description is view only by approved air support users.

Result Pay: 100% to first responder.

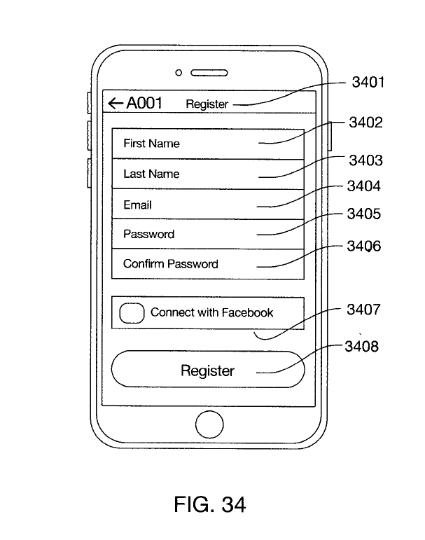

FIGS. 34-37 continues with the overall adding the user's personal profile information. FIG. 34 continues the registration process with register screen 3401 asking the user to create a user profile. As seen in FIG. 34, the user enters first name 3402, last name 3403, and email 3404. The user then provides password 3405 and confirm user's password 3406. The user can select to collect their personal information from Facebook using a “Connect with Facebook” option 3407. Then the user may select Register 3408 to register the user's profile.

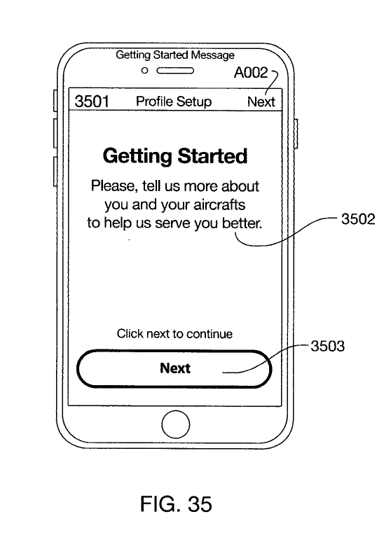

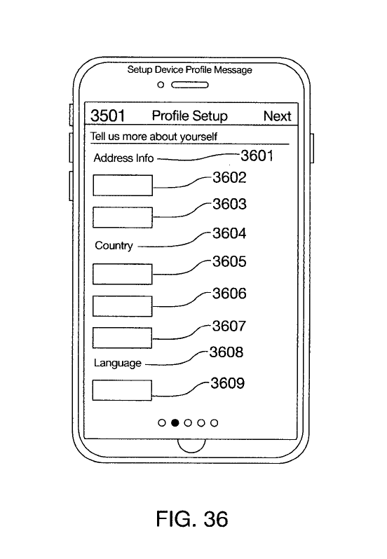

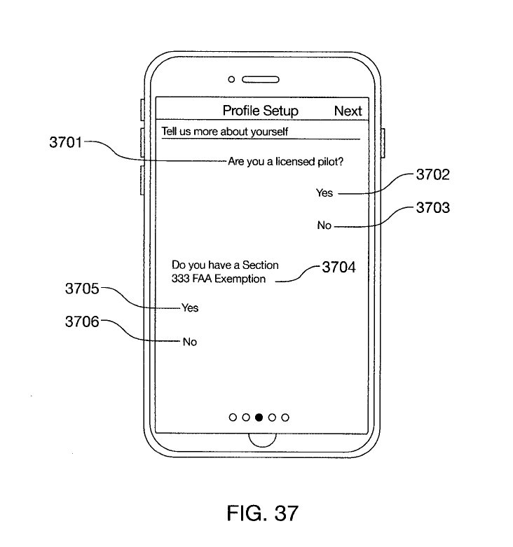

FIGS. 35-39 show screens that continue the user profile creation. The page shown in FIG. 35 continues profile setup 3501 and informs the user that additional profile information will be collected about the user and the user's aircrafts. The screen states 3502: “Getting Started. Please tell us more about you and your aircrafts to help serve you better”. The user selects “Next” 3503 to continue. FIG. 36 requests address 3601-3603, country 3604, city 3605, state 3606, zip code 3607, language 3608, and phone number 3609 from the user. Using the interface of FIG. 37, the user defines the user's aviation accomplishments. The screen asks 3701 “Are you a licensed pilot?” The use may either select yes 3702 or no 3703. The screen also asks 3704 “Do you have a 333 FAA Exemption”. The user can specify if the user has a Section 333 FAA exemption with a yes 3705 or a no 3706.

Note that FIGS. 34 and 35 display back (A001) and next (A002) features. These features allow user to move backward and forward through workflow screens as described herein.

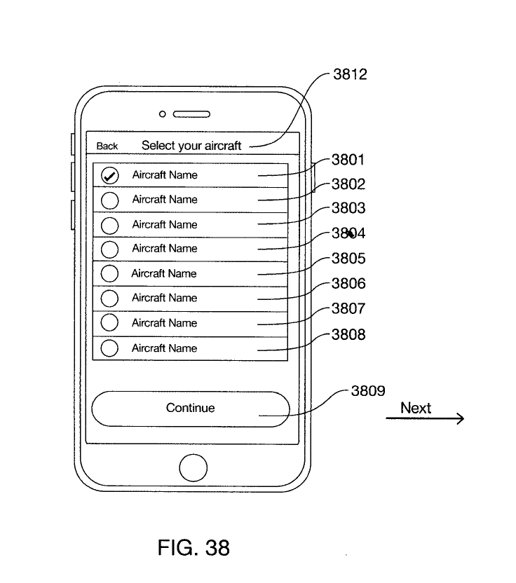

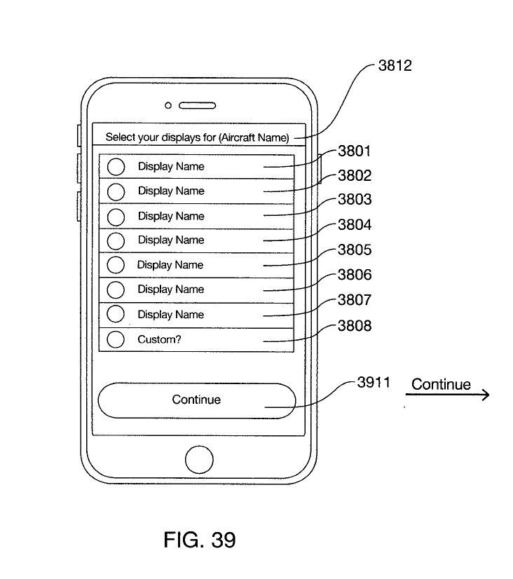

FIG. 38 requests a user to “Select your aircraft” 3812. FIG. 39 requests user to “Select your display for [Aircraft Name]” 3901. Using the screens of FIGS. 38 and 39, a user may indicate one or more devices 3801-3808 (i.e. drones) and one or more corresponding dependent displays 3902-3909. Under an embodiment, a user selects a single aircraft and then one or more corresponding dependent displays. FIG. 39 also allows the user to enter a display that may not be listed using a custom 3910 selection. A display may comprise a device running an application for display of drone data and providing control of drone operations.

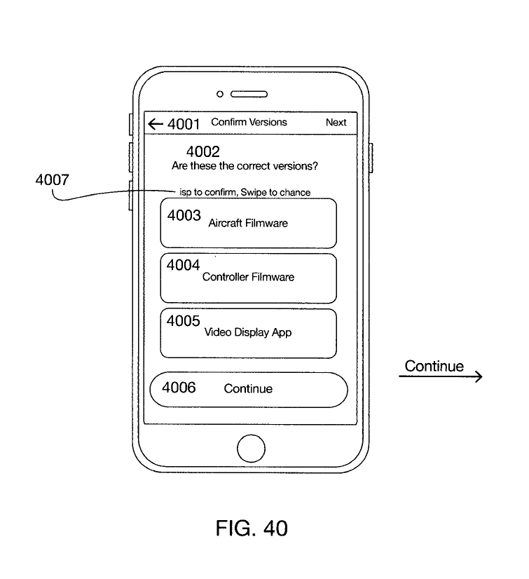

FIG. 40 presents a confirm versions screen 4001 and asks the user to verify and/or change the versions of software running on hardware whether drones or devices using confirm version screen. The screen asks “Are these the correct versions?” 4002 and with respect to this example allows the user to change the firmware for the aircraft 4003 and controller 4004. The user may also verify and/or change video display applications 4005. The screen instructs the user to 4007 “tap to confirm, swipe to change”. The interface of FIG. 40 allows the user to continue 4006 to the next screen.

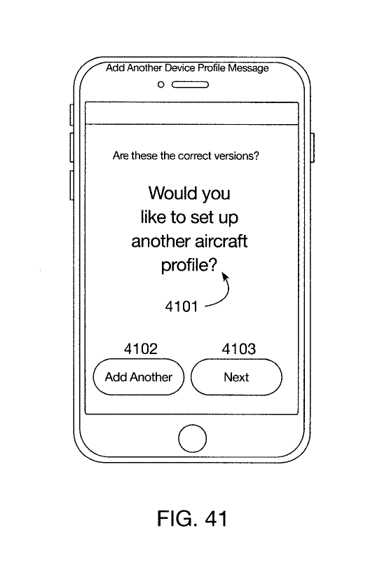

FIG. 41 asks the user “Would you like to set up another aircraft profile? ”4101. The user can select to add another 4102, or choose next 4103 to continue to complete the profile.

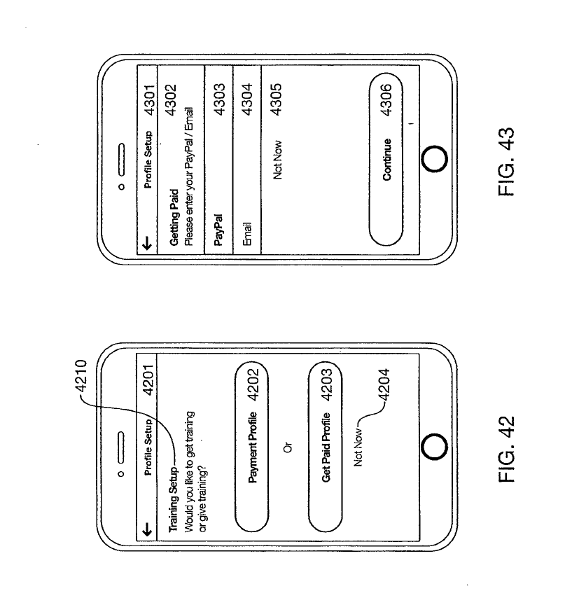

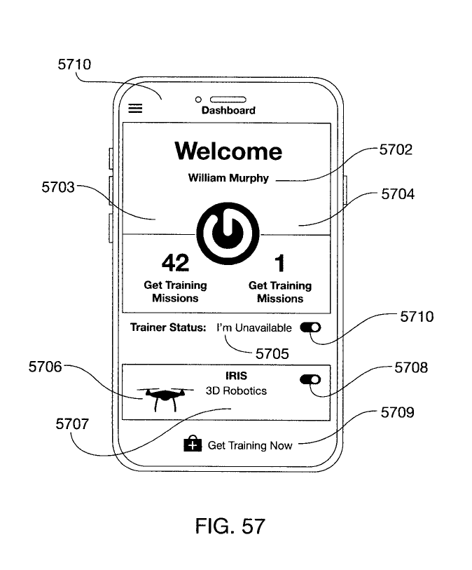

FIG. 42 sets up the payment profile for giving training or requesting training on the as part of profile setup 4201. The screen of FIG. 42 states “Training Setup: Would you like to get or give training?” 4210. The user can optionally set-up the payment profile 4202 or get paid profile 4203. The user is directed respectively to the screens of FIG. 45 and FIG. 43. The user may choose neither option by selecting “Not Now” 4204 which directs user to the FIG. 57 dashboard.

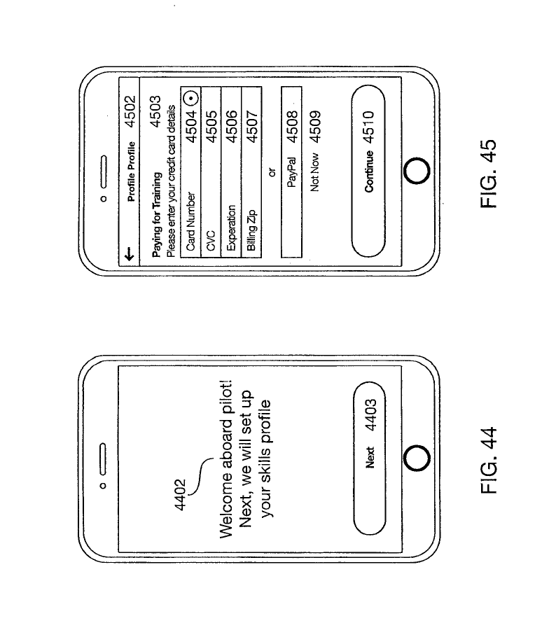

FIG. 43 is the payout profile 4301 for paying the user. The screen instructs the user “Getting Paid: Please enter your Paypal email” 4302. The user enters the user's Paypal information/email in fields 4303/4304. The user may then select continue 4306 which validates the Paypal account and continues to FIG. 44 to welcome the pilot aboard. Alternatively, the user may elect not to supply the requested information by selecting “Not Now” 4305 which directs user to the FIG. 45 payment profile.

FIG. 45 allows the user to set up a payment profile 4502 to pay for technical training with respect to operation/use of user's drone and devices selected during profile creation. The screen says, “Paying for Training, please enter your credit card information” 4503. The user enters credit card number 4504, CVC 4505, Expiration date 4506, billing zip code 4507, or the user can optionally choose to pay via Paypal 4508. When the paypal option is selected a screen like FIG. 43 will appear to collect the Paypal information. Once the user enters their payment information the user may validate the paypal and credit card information and forward to the dashboard of FIG. 57 by selecting Continue 4510. The user can opt not to enter of this payment information by selecting “Not Now” 4509 which directs user to the dashboard.

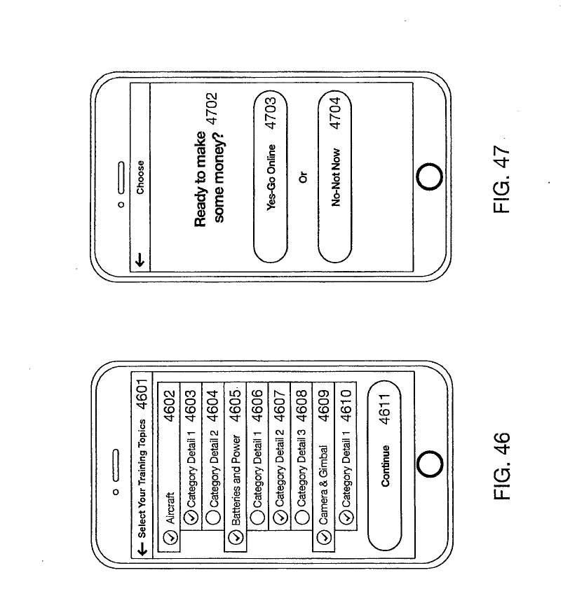

FIG. 44 welcomes the user aboard as a pilot by displaying “Welcome aboard pilot! Next, we will set up your skills profile.” 4402. The user selects “Next” 4403 to go to the skills profile screen (See FIG. 46).

FIG. 46 allows the user to select from a list of training topics on which the user can offer training as it relates to drones and corresponding devices and software/operating systems. FIG. 46 allows the user to “Select Your Training Topic” 4601. The user may select a category for drone aircraft 4602 (and one or more corresponding category details 4603, 4604), battery and power 4605 (and one or more corresponding category details 4606-4608), and Camera and Gimbal 4610 (and one or more corresponding category details 4610). The user may then continue 4611 to the screen shown in FIG. 47 further described below.

FIG. 47 allows the user the opportunity to make money for their drone aircraft expertise and asks “Ready to make some money?” 4702. The user can select “Yes—Go Online” 4703 or “No—Not Now” 4704. If the user chooses to make money by selecting the yes option, then the user is directed to the Dashboard of FIG. 57 at which time the dashboard training status may be set to “I'm Available” 5705. If the user chooses no, then user still proceeds to dashboard but remains unavailable to train.

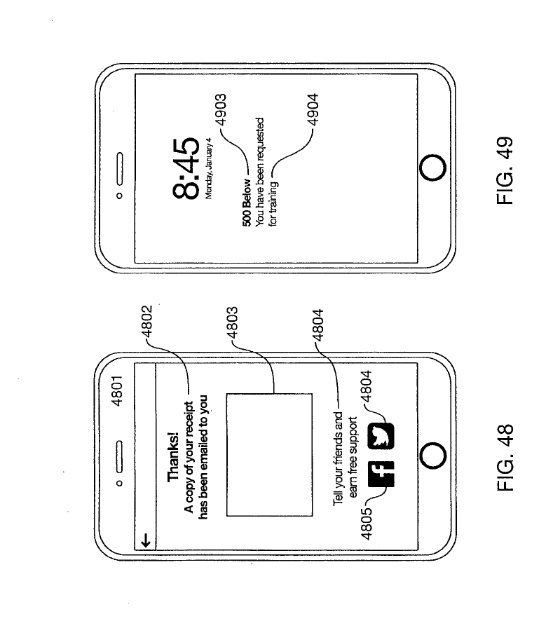

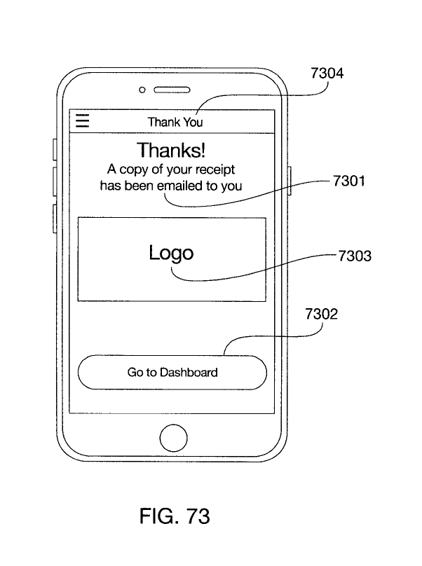

When users have previously received and paid for training, FIG. 48 thanks the trainee for using the application for training. It states “Thanks! A copy of your receipt has been emailed to you” 4802 to tell the user a receipt has been emailed. It displays 500Below's logo 4803. It requests for the user to tell people about their experience on social media by displaying “Tell your friends and earn free support!” 4804, where the user can invoke Facebook 4805 or Twitter 4806 to share their experience about the application. FIG. 48 is an embodiment of a thank you receipt analogous to FIG. 73 which is further described below.

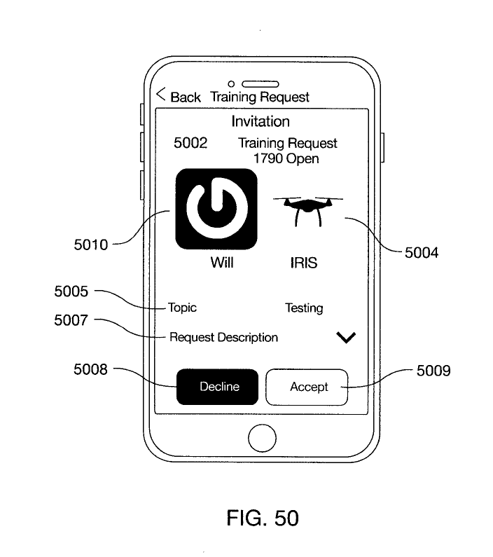

FIGS. 49-56 show the screens and the functionality of the trainer experience. When a user's training services are requested, a message displays on the user's cell phone as shown in FIG. 49. The message states, “500Below” on the first line 4904 and “You have been requested for training” on the second line 4903. The user can press their finger on the message and move the message to the right to invoke the 500Below application and move to FIG. 50. Note that a user may be forced to provide operating system specific credentials in order to launch the 500Below application.

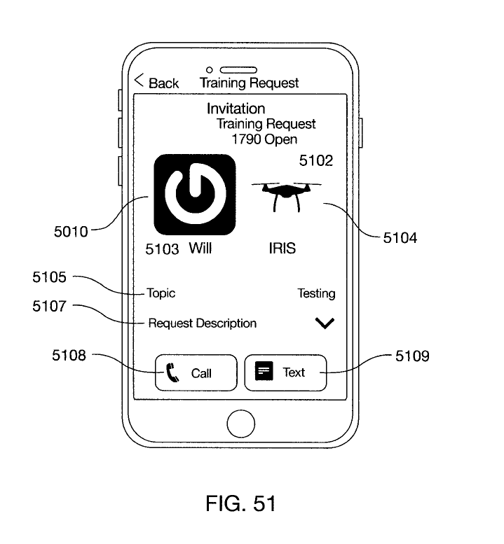

FIG. 50 displays “Training Request #179 Open” 5002. The number #179 refers to a unique number that is incremented for each new request. The requesting user's avatar or picture display 5010 (along with name 5003) and an image of their drone aircraft 5004 (along with aircraft name) are displayed. The topic for which the requesting user needs assistance is displayed 5005. The user may request a description 5007 of the request. The trainer/user user may choose to “Decline” 5008 (which returns user to dashboard of FIG. 57) or “Accept” 5009 the request. When the trainer/user selects “Accept” 5008, the user proceeds to FIG. 51 which enables communication between the trainer and trainee.

FIG. 51 allows the trainer or trainee to start a conversation. Both the trainee and the trainer see the same screen. Once the original request is accepted, either the requesting user or user/trainer (viewing the same screen) may initiate a phone call by selecting “Call” 5108 or text conversation by selecting “Text Chat” 5109. The rest of FIG. 51 displays much of the same information as FIG. 50. The number #179 refers to the unique number that's incremented for each new request. The requesting user's avatar or picture display 5110 (along with name 5103) and an image of user's drone aircraft 5104 (along with aircraft name) are displayed The topic for which the requesting user needs assistance is displayed 5105. The user may request a description 5107 of the request.

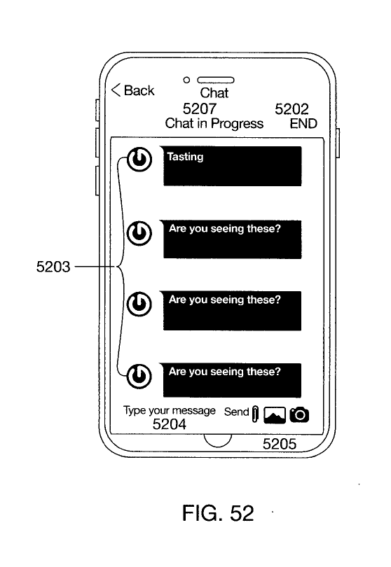

When “Text Chat” is selected, the user proceeds to the screen of FIG. 52. The screen states “Chat in progress” 5207 and displays the chat dialog 5203 between the requesting user and the responding user/trainer. The user may type a question and/or response in the field under “Type your message” 5204. Optionally a user may send an attachment 5205 by clicking on the paper clip (to attach locally stored file), on the image icon (to send locally stored picture), or on the camera icon to send a photo using the mobile device's native camera. Under one embodiment, only the trainer may terminate the training session by selecting END 5202. If END 5202 is not invoked, the trainee and trainer may go offline and still maintain the ability to resume the session later.

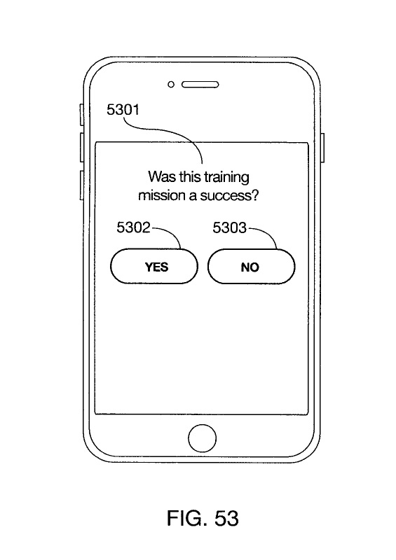

After the training completes then FIG. 53 appears and asks the trainer, “Was this training mission a success?” 5301. The use selects either “Yes” 5302 or “No” 5303. Under one embodiment, only the trainer evaluates whether the training session was a success but embodiments are not so limited

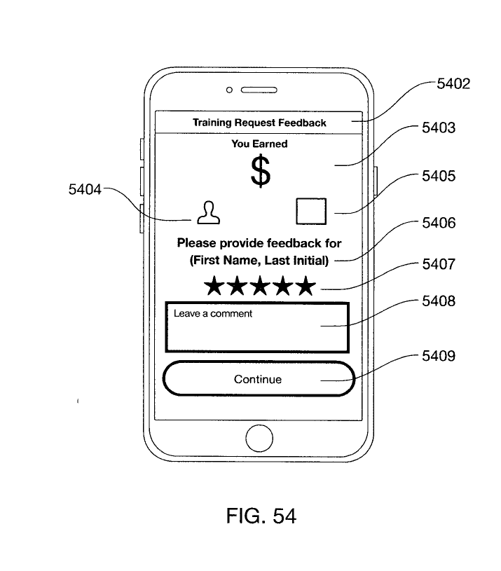

If the trainer selects yes, then the user/trainer proceeds to a training request feedback 5402 screen as seen in FIG. 54. The screen shows the income the trainer earned from completing the last call. It says at the top of the screen “You Earned” with the dollar amount earned 5403 from the previous training session. The screen also allows the trainer to provide feedback regarding the training session through the following request: “Please provide feedback for (First Name, Last Initial)” 5406. The aircraft image 5405 appears next to the trainee's image/avatar 5404. The trainer/user rates the training mission with one to five stars 5407. The trainer can leave comments using the “Leave a comment:” text box 5408. When the user finishes the rating, the user selects “Submit” 5409.

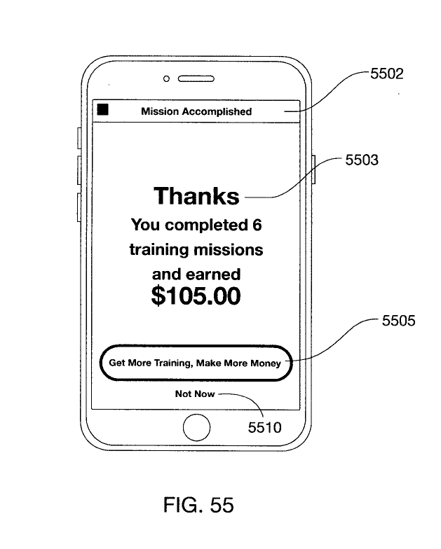

Upon completion of screen FIG. 54, the user proceeds to the “Mission Accomplished” 5502 screen of FIG. 55 which states “Thanks! You completed 6 training missions and earned $105.00” 5503. (The application totals all the training sessions and the total amount earned from all the training sessions the trainer user conducted). The user may then select a Get More Training, Make More Money option 5505. Alternatively, the user may elect the Not Now 5510 option.

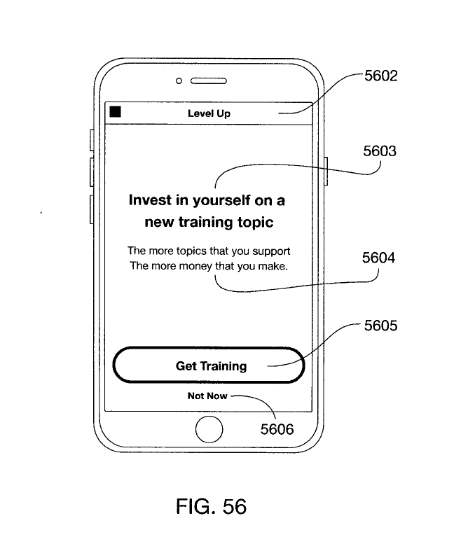

The Get More Training, Make More Money option 5505 of FIG. 55 directs user to the screen of FIG. 56 which encourages the user to improve the user's skills. It states “Invest in yourself on a new training topic” 5603. It continues to state, “The more topics that you support, the more money that you make” 5604. To get more training the user may select the Get Training option 5605. Alternatively, the user may elect the Not Now 5606 option. Either option leads directs a user to the dashboard of FIG. 57 under an embodiment.

If the trainer indicates that the training session is not a success by marking No in FIG. 53, the trainer is then also directed to FIGS. 54. However, FIG. 54 may then indicate that the trainer has not earned any money. Once the user completes the rating process of FIG. 54 and hits submit 5409, the user is returned to the Dashboard of FIG. 57.

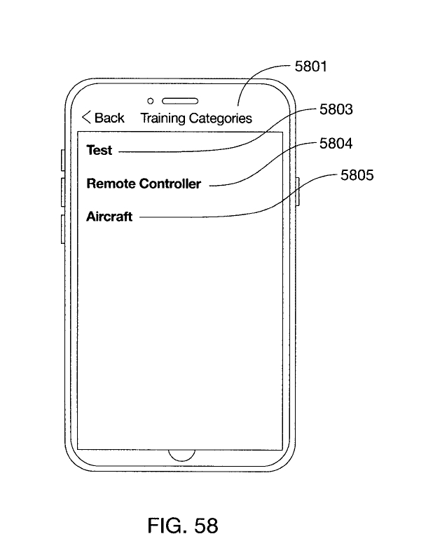

When a user chooses to get more training, the user is transferred the user to the dashboard of FIG. 57. The dashboard displays “Welcome” directly over the user name 5702. In this case the user's name is “William Murphy”. The dashboard displays the total number of trainings received 5703 by a user above the phrase “Get Training Missions” and shows the total number of trainings given 5704 by a user above the phrase “Give Training Missions”. In this case a user has received 42 training sessions and has provided 1 training session. A user may use the dashboard to broadcast availability to provide training. The center of the screen indicates trainer status 5705 (currently in the “I'm available mode”). A user may switch status from on to off using the I'm available toggle indicator 5710. The dashboard visually displays a user's expertise. The dashboard shows user's aircraft 5706, aircraft name 5707 (Iris, 3D Robotics), and a toggle indicator 5708 to switch availability for this particular training on or off. Under one embodiment a user may select on/off status for multiple devices. If the user would like to receive more training, the user may press the medical bag icon 5709 The phrase “Get Training Now” appears next to the medical bag icon. This feature invokes the screen of FIG. 58 as further described below.

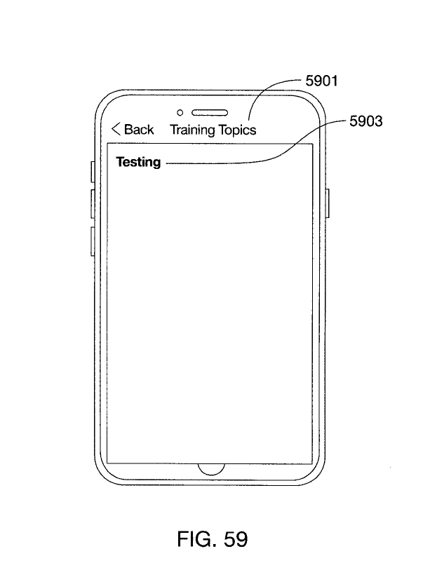

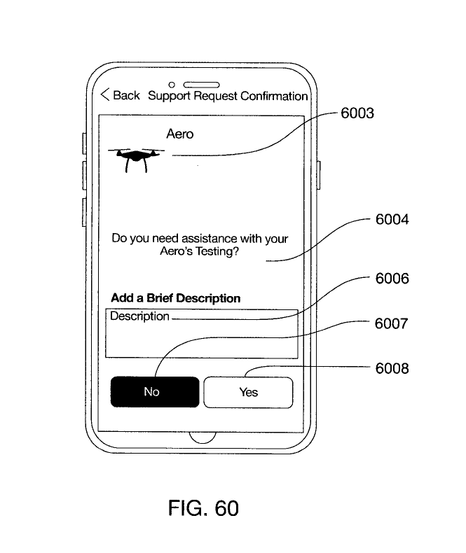

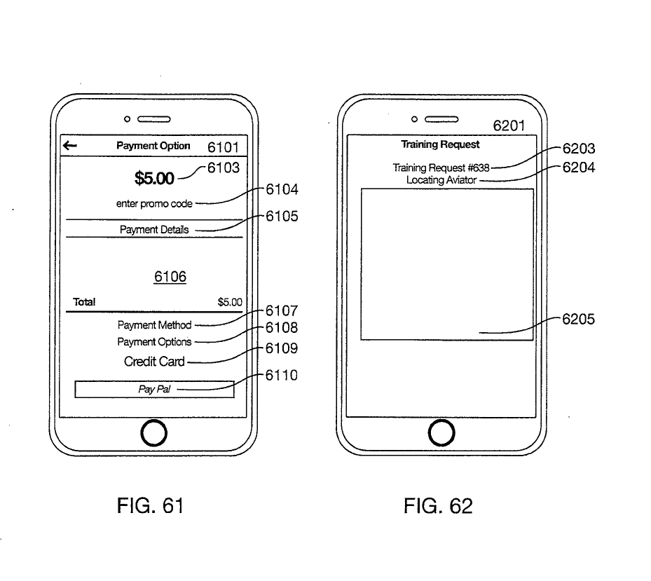

When the user invokes get training from the Dashboard FIG. 57, it invokes a series of sequential screens FIG. 58-FIG. 66. The screen of FIG. 58 allows a user to select training categories 5801. As seen in FIG. 58, a user may choose one or more training categories: test 5803, Remote Controller 5804, Aircraft 5805. Based on the selected training categories, the screen of FIG. 59 displays a list of corresponding training topics 5901. Here the user is presented with the training topic of testing 5903. When a user selects testing 5903, the screen of FIG. 60 presents a user with a picture of aircraft Aero 6003. Note that this screen may present one or more aircraft corresponding to devices registered in the user's profile. The screen asks “Do you need assistance with your Aero's testing?” 6004. The user may input a brief description 6006 regarding the requested training or any other matter of concern to the user. The user may then choose “No” 6007 or “Yes” 6008. Upon selecting “Yes” for training, the application workflow proceeds to the payment confirmation screen of FIG. 61 as further described below. Upon the user selecting “No” the user returns to the dashboard FIG. 57.

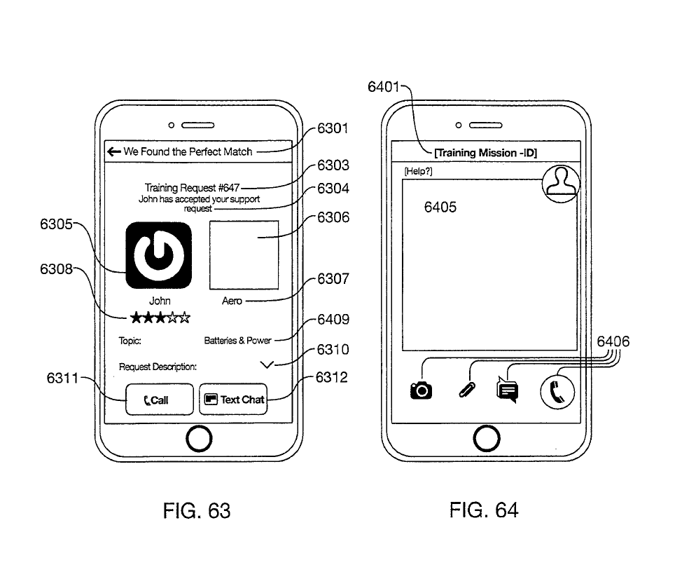

FIG. 61 represents a payment options 6101 page and present user with the payment amount 6103. The user may also enter a Promo Code 6104 to redeem any promotional offers. A payment details section 6105 presents a description 6106 of the training together with cost. A payment method section 6107 provides payment options: credit card 6109 or Paypal 6110. Upon confirmation of payment, FIG. 62 provides training request 6201 page. The screen of FIG. 62 specifies a training request number 6203. Here the training request number is #636. The screen indicates that the application is “Locating Aviator” 6204 as it searches for a matching trainer. The screen provides a GIF logo 6205. The logo may display a drone flying across the screen from left to right, between the word 500 and the word Below. When the application locates a matching trainer who understands the training requirements, the application invokes a screen saying “We Found The Perfect Match” 6301 as seen in FIG. 63. The screen indicates a specific training request number 6303. The screen identifies the name of the trainer stating that the trainer (John) has accepted the support request 6304. The screen displays the trainer's image and name 6305, the trainee's drone aircraft 6306, the name of aircraft 6307 (e.g. Aero), the trainer's star rating 6308, the topic for training 6409 (e.g., Batteries and Power). The interface of FIG. 63 allows a user to request a description 6310 of the training. The trainee may optionally place a call to the trainer by selecting “Call” the trainer 6311 or initiate a chat session with the trainer by selecting “Text Chat” 6312 to converse with the trainer.

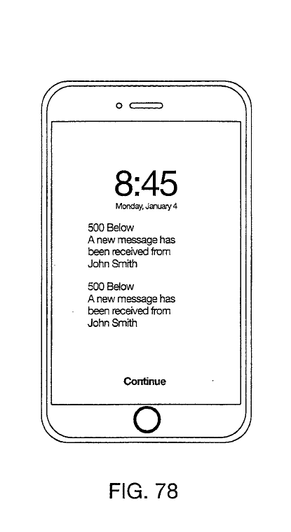

FIG. 64 shows the Training Mission 6401 page. The screen provides a session window 6405 proving a communication medium between trainer and trainee. During a session, both trainer and trainee may select among a variety of communication media as represented by the icons 6406 at the bottom of the screen. From left to right, either participant may select the camera icon to take/send photos, the paper clip icon to send locally stored files/images, the voice balloon icon to initiate chat functionality, or the phone icon to initiate voice calls. Under one embodiment, a Bluetooth™ icon (not shown) may provide wireless communication functionality. The session window may also provide voice chat under an embodiment. If a user drops from the session, the application preserves the session. A session participant may send the dropped party chat messages and the dropped party receives such messages 7801 on dropped party's phone screen as shown in FIG. 78. The messages state “500Below A new message has been received from [name of the user]. When the receiving user swipes the message to the right, the receiving user is returned to the Training Mission screen of FIG. 64, and the application restores the session to exactly where the session dropped.

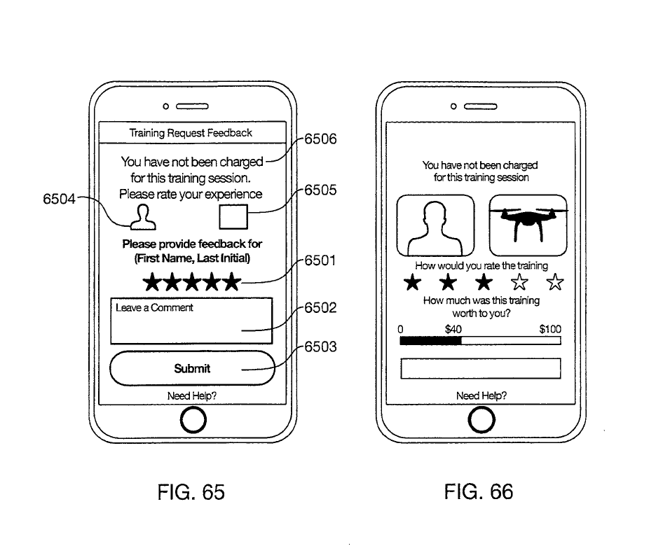

After the training completes, the trainer is asked whether the training session was successful. Although not shown here, this is accomplished using a screen analogous to the yes/no screen of FIG. 53. If the trainer selects no, then the user/trainee is presented with a series of screens from FIG. 65 to FIG. 68 that provide an evaluation workflow. FIG. 65 states: “You have not been charged for this training session. Please rate your experience” 6506. This screen shows the trainer's image 6504 and device 6505. This screen also requests a user to “Please provide feedback for (First Name, Last Initial)” using star a five star rating 6501. The user may also provide free form comments using text box 6502. The user may then submit the evaluation using a submit button 6503. FIG. 66 shows the screen FIG. 65 populated with actual content. Note that FIG. 66 may also provide user an opportunity to indicate how much the training is worth from the user's perspective on a sliding scale.

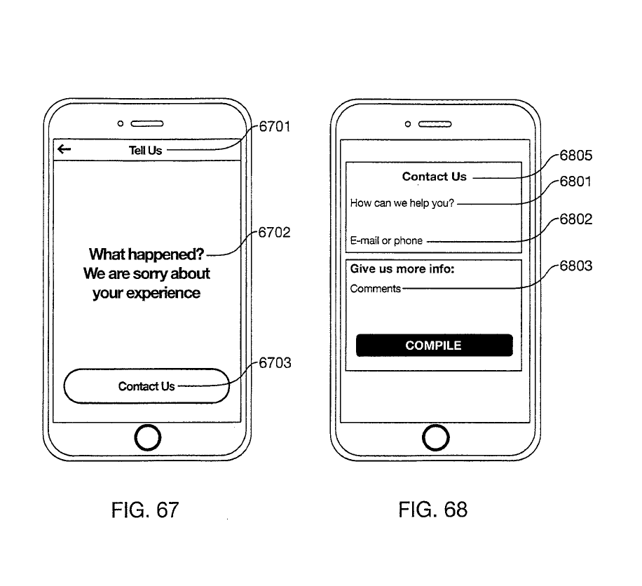

If the trainee rates the training session as three stars or more, the submit button 6503 directs the user to the dashboard (FIG. 57). But if the trainee rates the training as a two star or less and hits the submit button 6503, then the “Tell Us” screen 6701 of FIG. 67 appears. It asks on the screen “What happened? We are sorry about your experience” 6702. The screen offers “Contact Us” button 6703. When the “Contact Us” button is selected the Contact Us page 6805 of FIG. 68 appears. The screen says, “How can we help you?” 6801. It allows the user to enter email or phone number 6802 and provides a “Give us for information” 6803 input field. Selecting the “Continue” button 6804 returns user to dashboard of FIG. 57.

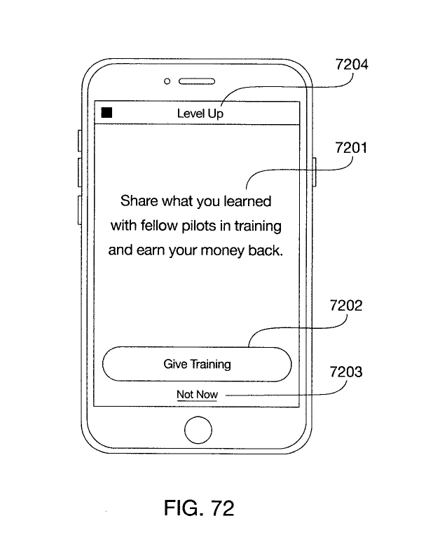

As indicated above, after the training completes, the trainer is asked whether the training session was successful. This is accomplished using a screen analogous to the yes/no screen of FIG. 53. If the trainer indicates yes, i.e. the training is successful, then the user/trainee is directed again to FIG. 65 and FIG. 66 (which are synonymous). However, FIG. 65 now indicates the trainee has been charged and the trainee's credit is consumed. The functionality of FIGS. 65 and 66 remain the same. The user/trainee may still rate the experience and leave comments. (Under one embodiment, FIG. 65 may now allow a user to adjust payment to include tip). If the user/trainee rates the session as two stars or less, then the user is directed to FIGS. 67 and 68 to provide feedback. The user then proceeds to the screens set forth in FIGS. 72-73. Under one embodiment, if the user submits a three star or greater rating, the user is automatically directed to the series of screens as seen in FIGS. 72-73 (i.e. bypassing the provide feedback pages). The first screen encountered, i.e. the “Level Up!” screen 7204 of FIG. 72, allows the user to add new training expertise to user's list of skills. This feature allows the user to expand the areas of expertise for conducting future trainings. The screen of FIG. 72 displays “Share what you learned with fellow pilots in training and earn your money back” 7201. The user can choose either to add the new training skills to their skillset by selecting “Give Training” 7202 (which invokes the training topics screen of FIG. 46) or “Not Now” 7203 which invokes the “Thank you” screen 7304 of FIG. 73. FIG. 73 begins with a message saying “Thanks! A copy of your receipt has been emailed to you” 7301. The screen also features the company logo 7303. The user may select the “Go to Dashboard” button 7302 to return to the Dashboard screen of FIG. 57.

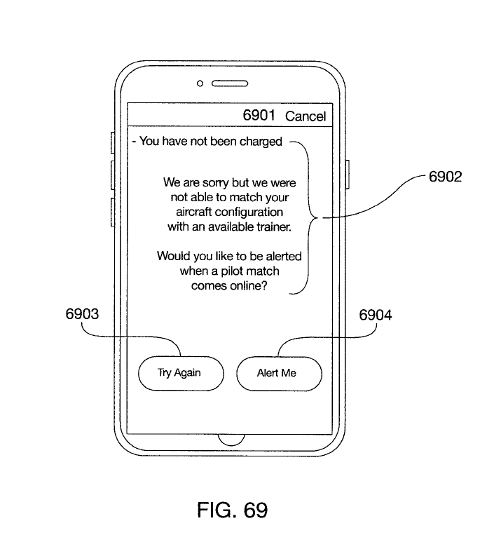

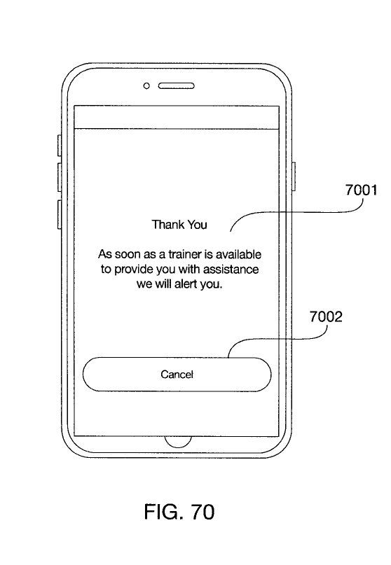

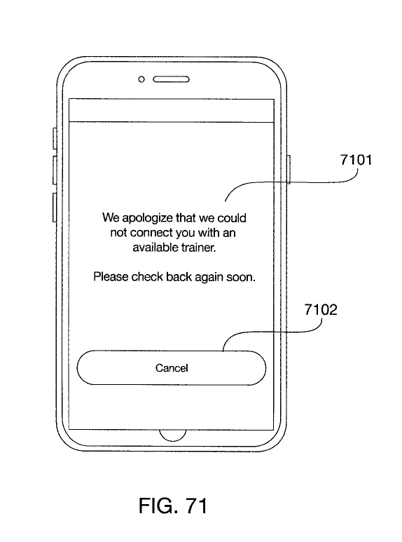

With respect to some training requests, a skilled and experienced trainer may not be available. At such times the user may pass from the “Training Request” screen 6201 of FIG. 62 to the screen of FIG. 69. The screen of FIG. 69 displays a message, “You have not been charged. We are sorry but we were not able to match your aircraft configuration with an available trainer. Would you like to be alerted when a pilot match comes online?” 6902. The user may choose to Cancel 6901 which invokes the screen of FIG. 71 which states “We apologize that we could not connect you with an available trainer. Please check back again soon” 7101. From FIG. 69, the user may also choose “Try Again” 6903 which submits the training request again immediately via the Training Request screen 6201 of FIG. 62. Or the user may choose “Alert Me” 6904 which alerts the user when an appropriate trainer does come online. The “Alert Me” option invokes the screen of FIG. 70 which says “Thank you. As soon as a trainer is available to provide you with assistance we will alert you” 7001. The Cancel option 7002, 7102 of FIG. 70 and FIG. 71 direct the user to the Dashboard of FIG. 57.

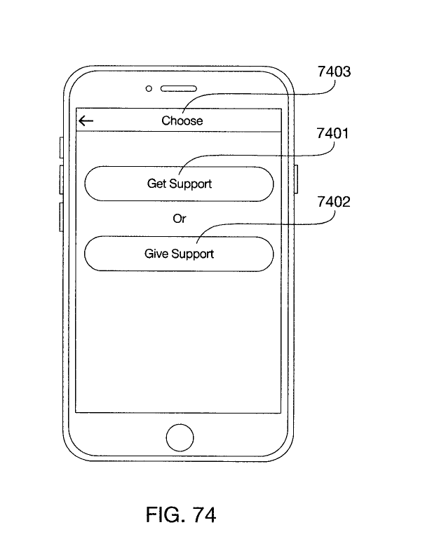

FIG. 74 shows a Choose screen 7403 that a user may see after the user signs into the application. The user choose may choose whether to “Get Support” 7401 for training or “Give Support” 7402 by offering training. Both options invokes the Dashboard screen FIG. 57. However the Give Support option 7402 toggles the availability indicator (FIG. 57, 5710) to an on or an available position.

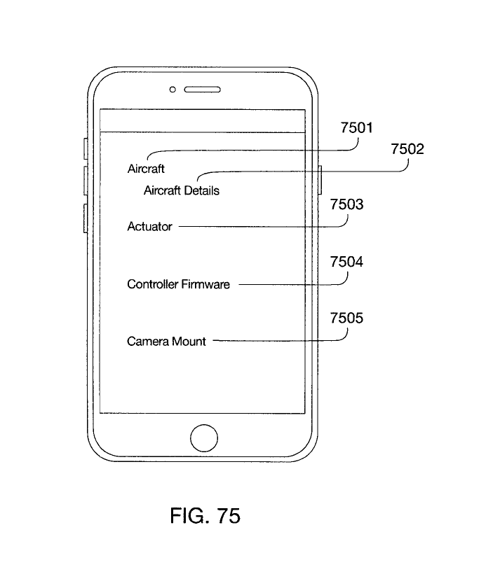

FIG. 75 provides an interface for updating a user/trainer skillset. This screen may be used to select or indicate Aircraft 7501 and Aircraft details 7502, Actuator (power supply) 7503, Controller Firmware 7504, and/or Camera Mount 7505. Selected items correspond to the trainer's skill set.

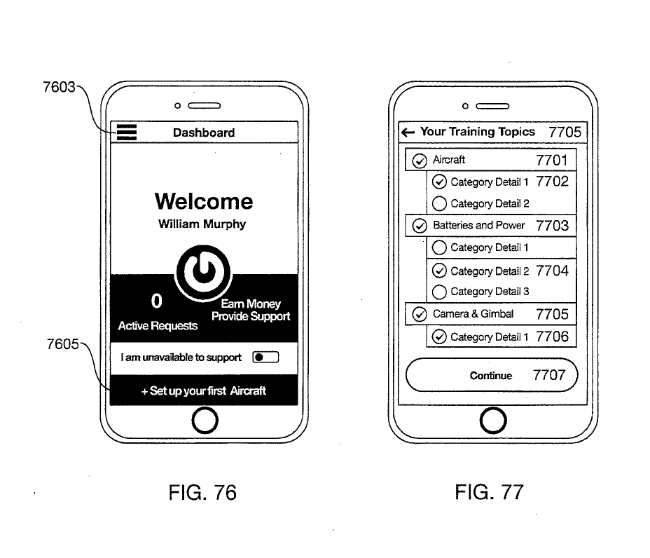

FIG. 76 shows an embodiment of the dashboard similar to that seen in FIG. 57. This version of the Dashboard only appears if the user has yet to add aircraft and supporting device training support topics into user's profile. This Dashboard operates much the same as the Dashboard in FIG. 57 with the exception that it allows user to immediately add training support topics by invoking “+Setup your first aircraft” 7605. When the user selects this option, the user proceeds to the “Your Training Topics” screen 7705 of FIG. 77. The screen of FIG. 77 allows the user to add aircraft selections, battery and power selections, and camera/gimbal selections using drop down menus. A user may select aircraft 7701 to introduce menu options 7702. A user may select battery and power 7703 to introduce menu options 7704. A user may select aircraft camera/gimbal 7705 to introduce menu options 7706. When the user completes the selections, the user may select the Continue button 7707 to invoke the main dashboard of FIG. 57.

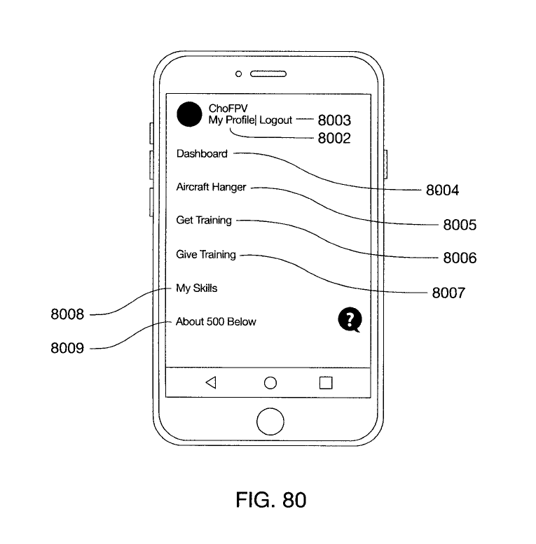

From either dashboard whether FIG. 57 or FIG. 76 the user may invoke a menu of the application functionality (as shown in FIG. 80) by selecting the 3 bars in the upper left 5710, 7603.

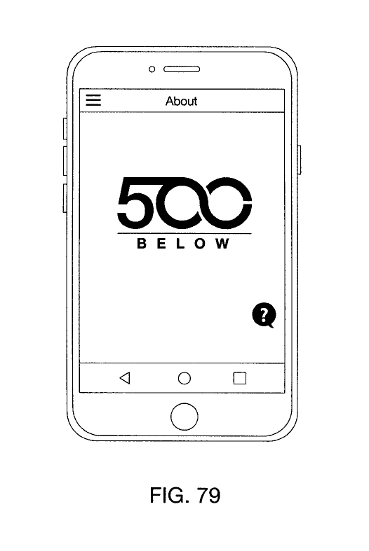

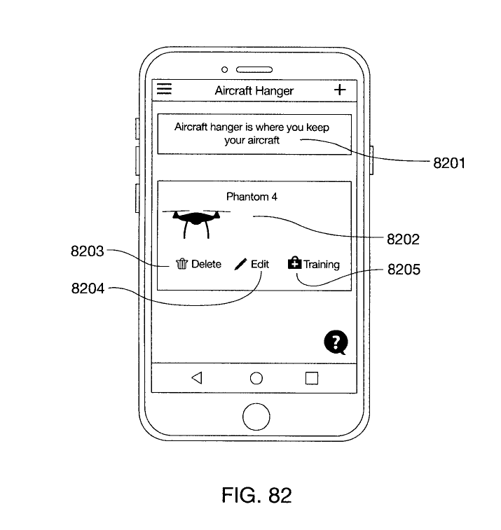

When the menu of applications screen FIG. 80 is invoked, the user may access any functional area within the application. This screen is invoked from the Dashboard (FIG. 57) and other screens that feature a 3 bar click through menu icon in the upper left corner of the screen. Using the menu icon, the user may access user's profile via “My Profile” 8002 (to view Profile Setup screen FIG. 36), logout of the application entirely 8003, access the “Dashboard” 8004 (shown by FIG. 57), access user's drone aircraft and supporting devices via “Aircraft Hanger” 8005 (which invokes the Aircraft Hanger screen FIG. 82), access training via “Get Training” 8006 (which invokes Training Categories of FIG. 58), give training via “Give Training” 8006 (to broadcast user availability for training), update user skills via “My Skills” 8008 (invoking the Select Your Training Topics of FIG. 46), or access “About 500Below” 8009 to see information about 500Below as shown in FIG. 79.

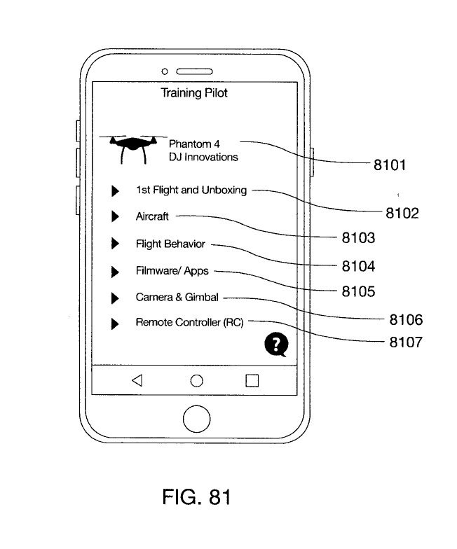

The Training Pilot screen of FIG. 81 allows the user to access and update user's skills in a manner analogous to FIG. 46. With respect to drone 8101 (Phantom, DJI Innovations), the screen of FIG. 81 shows categories 8102-8107 (1st Flight an Unboxing, Aircraft, Flight Behavior, Firmware,/Apps, Camera and Gimbal, Remote Controller).

The Aircraft Hanger screen 8206 of FIG. 82 states “Aircraft Hanger is where you keep your aircraft” 8201. It displays the user's aircraft 8202, and allows the user to Delete the aircraft 8203, Edit the aircraft 8204, or update Training 8205 as it pertains to this aircraft.

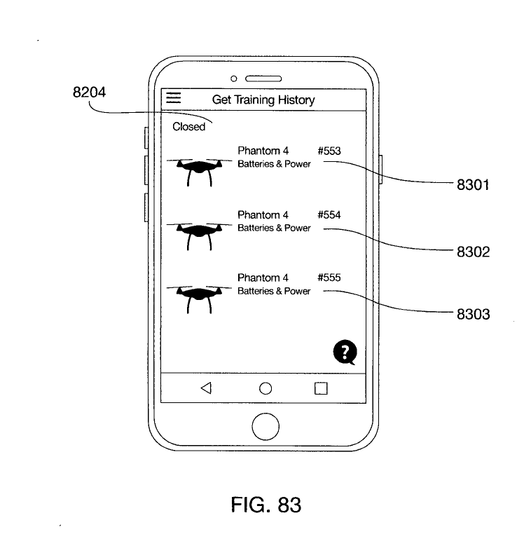

FIG. 83 shows a user's training history. The screen shows the following training sessions: Phantom 4, Batteries and Power #553 (8301); Phantom 4, Batteries and Power #554 (8302); Phantom 4, Batteries and Power #554 (8304).

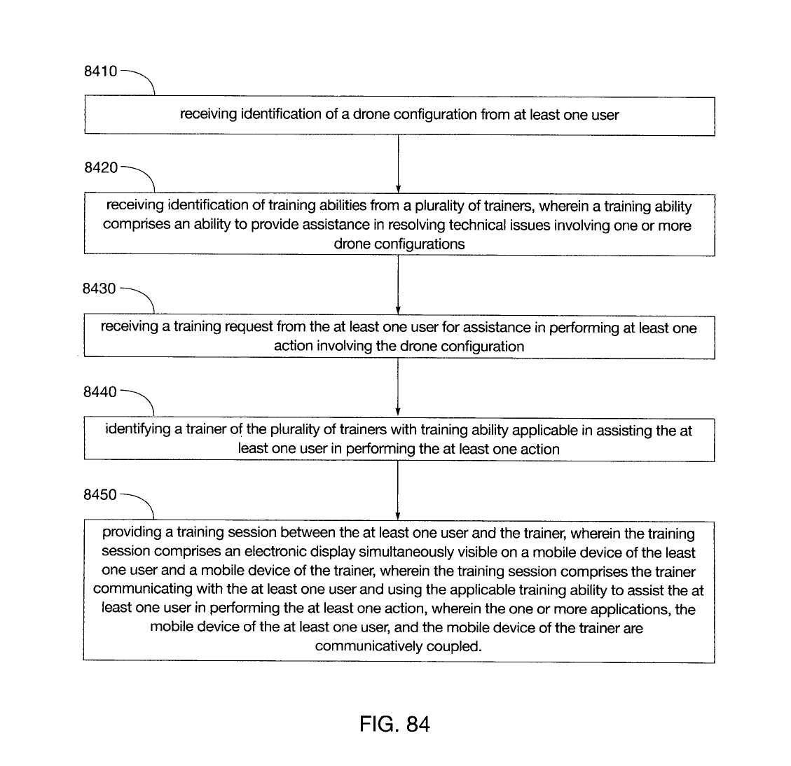

FIG. 84 shows a method for providing a peer to peer training session between two mobile computing devices including the step 8410 of receiving identification of a drone configuration from at least one user. The method includes the step 8420 of receiving identification of training abilities from a plurality of trainers, wherein a training ability comprises an ability to provide assistance in resolving technical issues involving one or more drone configurations. The method includes the step 8430 of receiving a training request from the at least one user for assistance in performing at least one action involving the drone configuration. The method includes the step 8440 of identifying a trainer of the plurality of trainers with training ability applicable in assisting the at least one user in performing the at least one action. The method includes the step 8450 of providing a training session between the at least one user and the trainer, wherein the training session comprises an electronic display simultaneously visible on a mobile device of the at least one user and a mobile device of the trainer, wherein the training session comprises the trainer communicating with the at least one user and using the applicable training ability to assist the at least one user in performing the at least one action, wherein the one or more applications, the mobile device of the at least one user, and the mobile device of the trainer are communicatively coupled.

Under one embodiment, a user may be able to tap a user's picture/image (as they appear anywhere in the application) to see that user's “History” in form of missions, comments, and ratings from previous missions. Under another embodiment, within a mission each user is able to tap the picture of the aircraft corresponding to the opposing user participant and view the aircraft's components and setup.

Under one embodiment, a matching algorithm of the 500Below application matches users with trainers using information from the user's profile and information regarding the features/topics supported by trainers. In establishing the user's profile, the user may provide the following information:

The user may under an embodiment indicate Primary Device, e.g. Aircraft (Inspire 1®, Phantom 1®, Phantom 2®, Phantom 2 Vision®, Phantom FC40®, Phantom 3®, etc).

The user may under an embodiment indicate Secondary Dependent Device or Component e.g. Remote Controller.

The user may under an embodiment indicate Dependent Display Device, e.g. mobile computing devices including iPad Mini and Android Galaxy S7.

The user may indicate Dependent Display Device Operating System, e.g. most current and prior versions of iOS and Android.

The user may under an embodiment indicate Accessories and Components in Use. The accessories/components are used in connection with the user's drone, e.g. Range Extenders, Prop Guards, Camera Devices, Camera Lenses, drone components used for agricultural surveys, etc.

The user may under an embodiment indicate 3rd Party Software. This software is different than manufacturer software made available to an owner of a particular drone aircraft. Manufacturer software may allow user to view aircraft speed, altimeter, camera setting, etc. Manufacturer software may also allow users to snap photos using the aircraft camera. Third party software is of course offered by developers other than the manufacturer. Third party software works together with manufacturer software, i.e. it takes data provided by manufacturer and presents it to the user in differing or enhanced formats, e.g. topology maps.

The profile information described above (e.g. Primary Device, Secondary Dependent Device or Component, Dependent Display Device, Dependent Display Device Operating System, Accessories in Use, and Third Party Software) comprises a “Bundled Configuration”. This Bundled Configuration is used to match users with other members in the network (i.e., trainers) who have opted to support certain features within the bundle. Under on embodiment, the algorithm matches trainers who support features that are a partial or exact match on the Bundled Configuration features.

If the matching algorithm identifies more than one trainer, the algorithm prioritizes trainers based on star rating.

Under one embodiment, the 500Below application may receive notices of firmware and software (manufacturer and third party) updates available for drone aircraft and dependent displays.

It is understood that systems and methods for providing peer to peer technical support for devices over a network as shown FIGS. 1-84 and as described herein are merely illustrative. Other arrangements may be employed in accordance the embodiments set forth below. Further, variations of the systems and methods for providing peer to peer technical support for devices over a network may comply with the spirit of the embodiments set forth herein.

A method is described herein that comprises one or more applications running on at least one processor of a remote server for providing receiving identification of a drone configuration from at least one user. The method includes receiving identification of training abilities from a plurality of trainers, wherein a training ability comprises an ability to provide assistance in resolving technical issues involving one or more drone configurations. The method includes receiving a training request from the at least one user for assistance in performing at least one action involving the drone configuration. The method includes identifying a trainer of the plurality of trainers with training ability applicable in assisting the at least one user in performing the at least one action. The method includes providing a training session between the at least one user and the trainer, wherein the training session comprises an electronic display simultaneously visible on a mobile device of the at least one user and a mobile device of the trainer, wherein the training session comprises the trainer communicating with the at least one user and using the applicable training ability to assist the at least one user in performing the at least one action, wherein the one or more applications, the mobile device of the at least one user, and the mobile device of the trainer are communicatively coupled.

The drone configuration of an embodiment includes a drone aircraft.

The drone configuration of an embodiment includes a dependent display device.

The dependent display device of an embodiment comprises one or more applications running on at least one processor of a mobile computing platform, wherein the one or more applications are communicatively coupled with the drone device.

The mobile computing platform of an embodiment includes an iOS™ operating system environment and an Android™ operating system environment.

The one or more applications of an embodiment display data captured by the drone aircraft and data relating to drone aircraft operations.

The drone configuration of an embodiment comprises a secondary dependent device, wherein the secondary dependent device includes a remote controller corresponding to the drone aircraft.

The drone configuration of an embodiment comprises accessories in use with respect to the drone aircraft.

The drone configuration of an embodiment comprises third party software, wherein the third party software receives data from manufacturer software relating to the drone aircraft, wherein the third party software uses the data to provide enhanced display formats.

The identifying a trainer of the plurality of trainers including identifying multiple trainers of the plurality of trainers under an embodiment.

The identifying multiple trainers including prioritizing the identified trainers based on each trainer's star rating under an embodiment.

The performing the at least one action including resolving at least one problem relating to the drone configuration under an embodiment.

The at least one problem includes a hardware issue under an embodiment.

The at least one problem includes a software upgrade issue under an embodiment.

The at least one problem includes a firmware upgrade issue under an embodiment.

The at least one problem includes a batteries and power issue under an embodiment.

The at least one problem includes at least one of a camera and gimbal mount issue under an embodiment.

The trainer and the at least one user use the electronic display to select at least one method of communication under an embodiment.

The at least one method of communication includes a chat session under an embodiment.

The at least one method of communication includes a voice call under an embodiment.

At least one method of communication includes under an embodiment exchanging one or more of locally stored files and images.

At least one method of communication includes under an embodiment use of a mobile device camera of the at least one user or a mobile device camera of the trainer to capture and exchange real time video.

At least one method of communication comprises under an embodiment Bluetooth™ communications.

The identifying the trainer including under an embodiment sending a training request invitation to the trainer's mobile device.

The training request invitation of an embodiment presents the training request.

The training request invitation of an embodiment presents the name of the at least one user, a graphical representation of the at least one user, and an image of the drone aircraft corresponding to the training request.

The identifying the trainer includes under an embodiment presenting trainer information to the at least one user.

The trainer information includes under an embodiment the name of the trainer, a graphical representation of the trainer, and an image of the drone aircraft corresponding to the training request.

The training information includes under an embodiment a one to five star rating of the trainer.

The method includes under an embodiment the trainer accepting the training request invitation and initiating the training session.

The method includes under an embodiment the trainer terminating the training session and indicating whether the training session is a success or a failure.

The method includes under an the trainer rating the session using at least one of a five star rating and a free form comments text box.

The method includes under an embodiment presenting confirmation of payment to the trainer when the training session is a success.

When the training session is a success, the method includes under an embodiment inviting the trainer to develop at least one additional training ability by submitting a training request using the one or more applications, wherein at least one user comprises the trainer.

The method includes under an embodiment the trainee rating the session using at least one of a five star rating and a free form comments box.

The method includes under an embodiment presenting confirmation of a charge to the at least one user when the training session is a success.

When the training session is a success, the method includes under an embodiment inviting the at least one user to provide training with respect to training abilities of the at least one user using the one or more applications, wherein the plurality of trainers comprises the at least one user.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The systems and methods for providing peer to peer technical support for devices over a network can be a component of a single system, multiple systems, and/or geographically separate systems. The systems and methods for providing peer to peer technical support for devices over a network can also be a subcomponent or subsystem of a single system, multiple systems, and/or geographically separate systems. The systems and methods for providing peer to peer technical support for devices over a network components can be coupled to one or more other components (not shown) of a host system or a system coupled to the host system.

One or more components of the systems and methods for providing peer to peer technical support for devices over a network and/or a corresponding interface, system or application to which the systems and methods for providing peer to peer technical support for devices over a network are coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the systems and methods for providing peer to peer technical support for devices over a network can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods for providing peer to peer technical support for devices over a network and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods for providing peer to peer technical support for devices over a network and corresponding systems and methods include: microcontrollers with memory (such as electronically erasable programmable read only memory (EEPROM)), embedded microprocessors, firmware, software, etc. Furthermore, aspects of the systems and methods for providing peer to peer technical support for devices over a network and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods for providing peer to peer technical support for devices over a network and corresponding systems and methods is not intended to be exhaustive or to limit the systems and methods to the precise forms disclosed. While specific embodiments of, and examples for, the systems and methods for providing peer to peer technical support for devices over a network and corresponding systems and methods are described herein for illustrative purposes, various equivalent modifications are possible within the scope of the systems and methods, as those skilled in the relevant art will recognize. The teachings of the systems and methods for providing peer to peer technical support for devices over a network and corresponding systems and methods provided herein can be applied to other systems and methods, not only for the systems and methods described above.

The elements and acts of the various embodiments described above can be combined to provide further embodiments. These and other changes can be made to the systems and methods for providing peer to peer technical support for devices over a network and corresponding systems and methods in light of the above detailed description.

What is claimed is:

1. A method comprising,
one or more applications running on at least one processor of a remote server for providing,
receiving identification of a drone configuration from at least one user;
receiving identification of training abilities from a plurality of trainers, wherein a training ability comprises an ability to provide assistance in resolving technical issues involving one or more drone configurations;
receiving a training request from the at least one user for assistance in performing at least one action involving the drone configuration;
identifying a trainer of the plurality of trainers with training ability applicable in assisting the at least one user in performing the at least one action;
providing a training session between the at least one user and the trainer, wherein the training session comprises an electronic display simultaneously visible on a mobile device of the at least one user and a mobile device of the trainer, wherein the training session comprises the trainer communicating with the at least one user and using the applicable training ability to assist the at least one user in performing the at least one action, wherein the one or more applications, the mobile device of the at least one user, and the mobile device of the trainer are communicatively coupled.

2. The method of claim 1, wherein the drone configuration includes a drone aircraft.

3. The method of claim 2, wherein the drone configuration includes a dependent display device.

4. The method of claim 3, wherein the dependent display device comprises one or more applications running on at least one processor of a mobile computing platform, wherein the one or more applications are communicatively coupled with the drone device.

5. The method of claim 4, wherein the mobile computing platform includes an iOS™ operating system environment and an Android™ operating system environment.

6. The method of claim 4, wherein the one or more applications display data captured by the drone aircraft and data relating to drone aircraft operations.

7. The method of claim 2, wherein the drone configuration comprises a secondary dependent device, wherein the secondary dependent device includes a remote controller corresponding to the drone aircraft.

8. The method of claim 2, wherein the drone configuration comprises accessories in use with respect to the drone aircraft.

9. The method of claim 2, wherein the drone configuration comprises third party software, wherein the third party software receives data from manufacturer software relating to the drone aircraft, wherein the third party software uses the data to provide enhanced display formats.

10. The method of claim 1, the identifying a trainer of the plurality of trainers including identifying multiple trainers of the plurality of trainers.

11. The method of claim 10, the identifying multiple trainers including prioritizing the identified trainers based on each trainer's star rating.

12. The method of claim 1, the performing the at least one action including resolving at least one problem relating to the drone configuration.

13. The method of claim 12, wherein the at least one problem includes a hardware issue.

14. The method of claim 12, wherein the at least one problem includes a software upgrade issue.

15. The method of claim 12, wherein the at least one problem includes a firmware upgrade issue.

16. The method of claim 12, wherein the at least one problem includes a batteries and power issue.

17. The method of claim 12, wherein the at least one problem includes at least one of a camera and gimbal mount issue.

18. The method of claim 1, wherein the trainer and the at least one user use the electronic display to select at least one method of communication.

19. The method of claim 18, wherein the at least one method of communication includes a chat session.

20. The method of claim 18, wherein the at least one method of communication includes a voice call.

21. The method of claim 18, wherein the at least one method of communication includes exchanging one or more of locally stored files and images.

22. The method of claim 18, wherein the at least one method of communication includes use of a mobile device camera of the at least one user or a mobile device camera of the trainer to capture and exchange real time video.

23. The method of claim 18, wherein the at least one method of communication comprises Bluetooth™ communications.

24. The method of claim 1, the identifying the trainer including sending a training request invitation to the trainer's mobile device.

25. The method of claim 24, wherein the training request invitation presents the training request.

26. The method of claim 24, wherein the training request invitation presents the name of the at least one user, a graphical representation of the at least one user, and an image of the drone aircraft corresponding to the training request.

27. The method of claim 24, the identifying the trainer including presenting trainer information to the at least one user.

28. The method of claim 27, the trainer information including the name of the trainer, a graphical representation of the trainer, and an image of the drone aircraft corresponding to the training request.

29. The method of claim 27, wherein the training information includes a one to five star rating of the trainer.

30. The method of claim 24, the trainer accepting the training request invitation and initiating the training session.

31. The method of claim 30, the trainer terminating the training session and indicating whether the training session is a success or a failure.

32. The method of claim 31, the trainer rating the session using at least one of a five star rating and a free form comments text box.

33. The method of claim 32, presenting confirmation of payment to the trainer when the training session is a success.

34. The method of claim 33, when the training session is a success, inviting the trainer to develop at least one additional training ability by submitting a training request using the one or more applications, wherein at least one user comprises the trainer.

35. The method of claim 30, the trainee rating the session using at least one of a five star rating and a free form comments box.

36. The method of claim 35, presenting confirmation of a charge to the at least one user when the training session is a success.

37. The method of claim 36, when the training session is a success, inviting the at least one user to provide training with respect to training abilities of the at least one user using the one or more applications, wherein the plurality of trainers comprises the at least one user.
